(19) United States
(12) Patent Application Publication
(10) Pub. No.: US 2024/0373312 A1
(43) Pub. Date: Nov. 7, 2024

(54) SYSTEM AND METHOD FOR EFFICIENT UPLOAD OR DOWNLOAD OF TRANSMISSION DATA OVER MOBILE ACCESS DEVICES

(71) Applicant: KONINKLIJKE PHILIPS N.V., EINDHOVEN (NL)

(72) Inventor: Oscar Garcia Morchon, Eindhoven (NL)

(21) Appl. No.: 18/288,587

(22) PCT Filed: Apr. 29, 2022
(86) PCT No.: PCT/EP2022/061617

§ 371 Date: Oct. 27, 2023

(30) Foreign Application Priority Data
Apr. 30, 2021 (EP) 21171430.8
May 15, 2021 (EP) 21173985.9
Aug. 2, 2021 (EP) 21189071.0
Mar. 28, 2022 (EP) 22164790.2

(51) Int. Cl. H04W 36/32; H04W 36/02; H04W 36/08; H04W 36/36

(52) U.S. Cl. CPC H04W 36/322; H04W 36/023; H04W 36/087; H04W 36/362

(57) ABSTRACT

The invention proposes an improved provision of download capability for terminal devices (e.g. smart phones or IoT devices) in a network system by introducing a capability of caching requested data at mobile access devices (e.g. base stations (such as gNBs) or access points) and optimizing scheduling/transfer of data between terminal device and mobile access device and between mobile access device and macro access device.

### FIELD OF THE INVENTION

The invention relates to data distribution in wireless networks including mobile access devices, such as—but not limited to—cellular networks.

### BACKGROUND OF THE INVENTION

Small cell technology is a new development in cellular networks of the fifth generation (5G networks), but small cells aren't the only access devices (i.e. base stations or node Bs) that will provide network connectivity. 5G networks also use macro cells—such as cell towers—for connectivity, and these larger base stations may enable lower 5G frequencies, compared to small cell's high-frequency millimeter wave capabilities.

A macro cell may be a cellular base station that sends and receives radio signals through large towers and antennas to provide cellular coverage in a km range, while a small cell is another type of cellular base station that is physically small to boost wireless network connectivity in specific areas with high-speed broadband connectivity. Moreover, a femtocell may be a wireless access point used to enhance indoor cellular connectivity. Unlike other cellular connectivity options, femtocells connect back through the internet to provide in-home or office cellular connectivity. Femtocells look and operate like routers, and users can place femtocells near their current network hardware setups. Femtocells are accessible to anyone who wants to purchase one.

In some situations, terminal devices (such as mobile user devices (e.g. mobile phones such as user equipment (UE), smartphones, laptops, notebooks, tablets etc.) or Internet of Things (IoT) devices (e.g. sensors or the like) might have high bandwidth needs, e.g., due to a required download of a big data file. Retrieving such a big data file may however cause problems while being connected to a macro cell of a cellular network if the macro cell can provide limited connectivity only, or if a terminal device has to get connected to a mobile relay (e.g. mobile cellular access device such as a gNodeB (gNB) in 5G networks) first and can only then trigger the download of a file since the mobile relay might be able to provide good/fast connectivity for a very limited amount of time.

An exemplary use case may be a UE that is connected to the cellular network through a macro cell and requires some bandwidth needs that cannot be fully handled by the current macro cell. For instance, a medical user might be having a video conference and also requesting the download of a big genomic file, or a travelling user is trying to retrieve some videos, but the current connectivity through the macro cell does not support the connection.

### SUMMARY OF THE INVENTION

It is an object of the present invention to enable improved data distribution in wireless networks.

This object is achieved by an apparatus as claimed in claim 1, by a wireless communication system as claimed in claim 6, by a terminal device as claimed in claim 14, by a method as claimed in claim 15, and by a computer program product.

According to a first aspect related to a core network device or function (e.g. AMF, SMF or IAB coordinator) or a terminal device (target device) of the wireless network, an apparatus for controlling upload or download of transmission data in a wireless network is provided, wherein the apparatus is configured to:
select a mobile access device based on estimated location information of the mobile access device and location information of a target device; and
schedule a transfer of the transmission data to the access device and a subsequent transfer of the transmission data from the access device to the target device or to a core network of the wireless network based on the estimated location information of a mobile access device and the location information of the target device.

According to a second aspect related to the core network device or function or the terminal device (target device), a method of controlling upload or download of transmission data in a wireless network is provided, wherein the method comprises:
selecting a mobile access device based on estimated location information of the mobile access device and location information of a target device; and
scheduling a transfer of the transmission data to the mobile access device and a subsequent transfer of the requested data from the mobile access device to the target device or to a core network of the wireless network based on the estimated location information of the mobile access device and the location information of the target device.

According to a third aspect related to the core network device or function or the terminal device (target device), a method of controlling upload or download of transmission data in a wireless network is provided, wherein the method comprises:
selecting a mobile access device based on estimated location information of the mobile access device and location information of a target device; and
scheduling a transfer of the transmission data between target device and core network through the mobile access device based on the estimated location information of the mobile access device, the location information of the target device and the estimated location of the mobile access device that optimizes the communication performance.

The communication performance may include for example the end to end throughput (average or instantaneous), the overall network throughput (average or instantaneous), the most efficient communication in terms of power consumption, the lowest level of interference. Other metrics could be taken into account for the optimal communication performance definition, like the throughput time, the data rate, or the latency.

According to a fourth aspect, a wireless communication system is provided, which comprises an apparatus of the first aspect and at least one mobile access device.

According to a fifth aspect, a terminal device (e.g. wireless communication device (UE) or IoT device is provided, which comprises an apparatus of the first aspect.

Finally, according to a sixth aspect, a computer program product is provided, which comprises code means for producing the steps of the above method of the second aspect when run on a computer device.

Accordingly, better upload or download capability for target devices (e.g. terminal devices, IoT devices etc.) can be achieved by using the mobile access device between the target device and a donor access device to optimize at least one of mobility and network topology, transfer of data e.g. by caching requested data at the mobile access device and allocating communication parameters between the target device and the mobile access device and/or between the mobile access device and the macro access device. The donor access device might be a macro cell or any other cell, e.g., pico/femto/small cell, stationary or mobile, capable of providing connectivity to the mobile access device.

As the above optimization is based on positioning information of the mobile access device, the communication can be prepared in advance in such a way that data communication is not affected, the upload or download of a related file is put on hold in the macro cell e.g. since it is currently overloaded, the mobile access device starts caching the upload or download of the requested data, and the target and mobile access devices can be made aware of their positions/trajectories to adapt and plan their radio access network (RAN) communication settings.

According to a variant which may be used in any of the first to sixth aspects of the invention, it is proposed that the apparatus is configured to initiate caching the transmission data at the selected mobile access device.

According to a first option which may be combined with any of the above first to sixth aspects, the requested data may be uploaded or downloaded via a macro access device when the mobile access device is in a predetermined range of the macro access device. Thereby, it can be assured that the transmission data is transferred over a short distance to achieve an improved connectivity.

According to a second option which may be combined with the first option or any of the above first to sixth aspects, the transmission data may be a data file to be uploaded or downloaded, a data stream from a streaming service, or a software update. Thus, large amounts of data can be transferred more effectively to or from the target device via the mobile access device.

According to a third option which can be combined with the first or second option or any of the above first to sixth aspects, it may be determined which of a plurality of mobile access devices will be in a predetermined range of the target device taking into account current traveling schedules of the mobile access devices and it may be identified which of the plurality of mobile access devices can deliver the transmission data to the target device taking into account the position information of the target device at a predetermined time, the positions of each of the plurality of mobile access devices at the predetermined time, and communication requirements of a user of the target device at the predetermined time. Thereby, a best suited mobile device can be selected for effective transfer of the transmission data.

According to a fourth option which can be combined with any of the first to third options or any of the above first to sixth aspects, the selected mobile access device may be informed about at least one of a presence of the target device along a route of the mobile access device, data requirements of the user of the target device, and a position of the target device, so that the selected mobile access device can pre-optimize transmission parameters or pre-allocate transmission resources. Thereby, effective transfer of the transmission data can be ensured at the mobile access device.

According to a fifth option which can be combined with any of the first to fourth options or any of the above first to sixth aspects, the target device may be informed through a macro cell about the timing when the mobile access device will be in reach and available for upload or download of the transmission data. Thus, the target device is enabled to prepare an effective transfer of the transmission data.

According to a sixth option which can be combined with any of the first to fifth options or any of the above first to sixth aspects, a suitable location of the mobile access device for the transfer of the transmission data and a suitable starting time for the uplink or downlink communication between the selected mobile access device and a macro access device serving the target device are selected. Thereby, effective scheduling of the transfer(s) of the transmission data can be achieved.

According to a seventh option which can be combined with any of the first to sixth options or any of the above first to sixth aspects, the transmission data may be transferred through two or more mobile access devices if a single mobile access device is not able to handle all the transmission data.

According to an eighth option which can be combined with any of the first to seventh options or any of the above first to sixth aspects, the mobile access device may be a vehicle-mounted access device configured to serve terminal devices located in the vehicle or in a predetermined range of the vehicle. Thereby, a plurality of mobile access devices can be provided on public transportation vehicles with predetermined travelling routes and schedules to facilitate effective scheduling of the transfer of the transmission data and provide enhanced connectivity.

According to a ninth option which can be combined with any of the first to eighth options or any of the above first to sixth aspects, the mobile access device may comprise an intermediate user plane function (I-UPF) or a local application function (AF) or is configured to host of an edge computing application or an edge application server. This measure provides the advantage that the transfer of the transmission data from the data source to the mobile access device can be made more effective.

According to a tenth option which can be combined with any of the first to ninth options or any of the above first to sixth aspects, the mobile access device may be configured to pre-allocate and configure communication resources for the upload or download of the transmission data taking into account one or more of the following: a required amount of data to transfer, the position information of the target device, an expected trajectory of the mobile access device, an expected time period during which the target device or a macro access device and the mobile access device will be in a predetermined range. Thereby, the transfer of the transmission data can be optimized at the mobile access device.

According to an eleventh option which can be combined with any of the first to tenth options or any of the above first to sixth aspects, a core network function may be configured to trigger a request for a conditional handover to the mobile access device once the mobile access device has been selected, or the target device may be configured to send a radio resource control measurement report triggering the conditional handover request, or the target device may be configured to send a request to trigger the conditional handover directly to a core network of the wireless network, or the target device may be configured to join the mobile access device if it fulfils predetermined conditions. Thereby, the data transfer via the mobile access device can be effectively initiated by a handover operation.

According to a twelfth option which can be combined with any of the first to eleventh options or any of the above first to sixth aspects, the mobile access device and a macro access device serving the target device may be instances of a split between a central unit and a distributed unit, wherein the mobile access device is a distributed unit and the macro access device is a central unit, wherein the central unit is configured to send to the target device a connection reconfiguration message including timing and conditions for moving from a source distributed unit to a target distributed unit, wherein the target device is configured to include information about a data delivery status in a random-access procedure and/or a connection reconfiguration complete message, and wherein the transmission data is cached at the target distributed unit. These measures facilitate handover-based data transfer via mobile access devices.

According to a thirteenth option which can be combined with any of the first to twelfth options or any of the above first to sixth aspects, an integrated access and backhaul (IAB) donor unit may be provided, that is configured to create communication parameters in dependence on an estimated mobility information of the mobile access device, to activate the communication parameters when the mobile access device is in a predetermined range of the IAB donor unit, and to put the communication parameters on hold when the mobile access device is out of range of the IAB donor unit. Thereby, it can be ensured that proper communication parameters are readily available when the transmission data is to be transferred.

According to a fourteenth option which can be combined with any of the first to thirteenth options or any of the above first to sixth aspects, the transmission data may be distributed in a mobile edge or multi-access edge computing (MEC) environment, wherein an MEC orchestrator of a core network of the wireless network may be configured to select the mobile access device for delivering the transmission data to the target device, wherein an MEC application is first commissioned at the selected mobile access device and the transmission data is transferred upon request of the MEC orchestrator based on an application request from the target device. This ensures effective transfer of the transmission data from an application to the target device via the selected mobile access device.

According to a fifteenth option which can be combined with any of the first to fourteenth options or any of the above first to sixth aspects, a macro access device serving the target device may be configured to collect positioning information of the mobile access device during a learning phase and to use the collected positioning information during a prediction phase to estimate an actual position of the mobile access device. Thereby, an effective scheduling of the transfer of the transmission data and an improved connectivity during the transfer can be achieved.

According to a sixteenth option which can be combined with any of the first to fifteenth options or any of the above first to sixth aspects, the terminal device may be configured to decide whether to connect to the mobile access device based on at least one of the location information of the target device and the estimated location information of the mobile device.

It is noted that the above apparatus may be implemented based on discrete hardware circuitries with discrete hardware components, integrated chips, or arrangements of chip modules, or based on signal processing devices or chips controlled by software routines or programs stored in memories, written on a computer readable media, or downloaded from a network, such as the Internet.

It shall be understood that the apparatus of claim 1, the wireless communication system of claim 7, the terminal device of claim 15, the method of claim 16, and the computer program product may have similar and/or identical preferred embodiments, in particular, as defined in the dependent claims.

It shall be understood that a preferred embodiment of the invention can also be any combination of the dependent claims or above embodiments with the respective independent claim. These and other aspects of the invention will be apparent from and elucidated with reference to the embodiments described hereinafter.

### BRIEF DESCRIPTION OF THE DRAWINGS

In the following drawings:

FIG. 1 schematically shows an architecture of a cellular network in which the present invention can be implemented;

FIG. 2 schematically shows an example according to an embodiment of a planned data download to an off-board terminal device from a mobile base station;

FIG. 3 schematically shows a signaling and processing diagram for the planned data download of the example of FIG. 2;

FIG. 4 schematically shows a signaling and processing diagram for a data distribution in a mobile edge computing (MEC) environment according to an embodiment;

FIG. 5 schematically shows a block diagram of an exemplary instantiation of a mobile base station and overall system according to various embodiments;

FIG. 6 schematically shows a signaling and processing diagram for an example according to an embodiment where a downlink data is cached at a mobile base station until it can be delivered;

FIG. 7 schematically shows a flow diagram of a first responder network localization and mapping procedure according to various embodiments;

FIG. 8 shows characteristic curves of downlink throughput between macro and mobile base stations vs. location based on historical data;

FIG. 9 shows characteristic curves of downlink throughput between two mobile base stations and a terminal device vs. location based on historical data:

FIG. 10 schematically shows an example according to an embodiment of a planned data download to an off-board terminal device through a mobile base station;

FIG. 11 shows characteristic curves of downlink throughput between macro and mobile base stations and between mobile base station and UE vs. location based on historical data. This figure shows locations L1 and L3 for optimizing the individual communication links and location L2 for optimizing the end-to-end communication link; and

FIG. 12 shows characteristic curves of downlink throughput between macro and mobile base stations and between mobile base station and UE vs. location based on historical data.

FIG. 13 shows a beam forming arrangement for the broadcast of the synchronization signal block through different beams where the beams are arranged relative to the traveling direction of the mobile base station.

FIG. 14 shows a beam forming arrangement for the broadcast of the synchronization signal block through different beams where the beams keep a fixed arrangement independent of the traveling direction of the mobile base station.

### DETAILED DESCRIPTION OF EMBODIMENTS

Embodiments of the present invention are now described based on a 5G cellular network environment.

Throughout the present disclosure, the abbreviation “gNB” (5G terminology) is intended to mean access device such as a cellular base station or a WiFi access point. The gNB may consist of a centralized control plane unit (gNB-CU-CP), multiple centralized user plane units (gNB-CU-UPs) and/or multiple distributed units (gNB-DUs). The gNB is part of a radio access network (RAN), which provides an interface to functions in the core network (CN). The RAN is part of a wireless communication network. It implements a radio access technology (RAT). Conceptually, it resides between a communication device such as a mobile phone, a computer, or any remotely controlled machine and provides connection with its CN. The CN is the communication network's core part, which offers numerous services to customers who are interconnected via the RAN. More specifically, it directs communication streams over the communication network and possibly other networks.

It is noted that throughout the present disclosure only those blocks, components and/or devices that are relevant for the proposed data distribution function are shown in the accompanying drawings. Other blocks have been omitted for reasons of brevity.

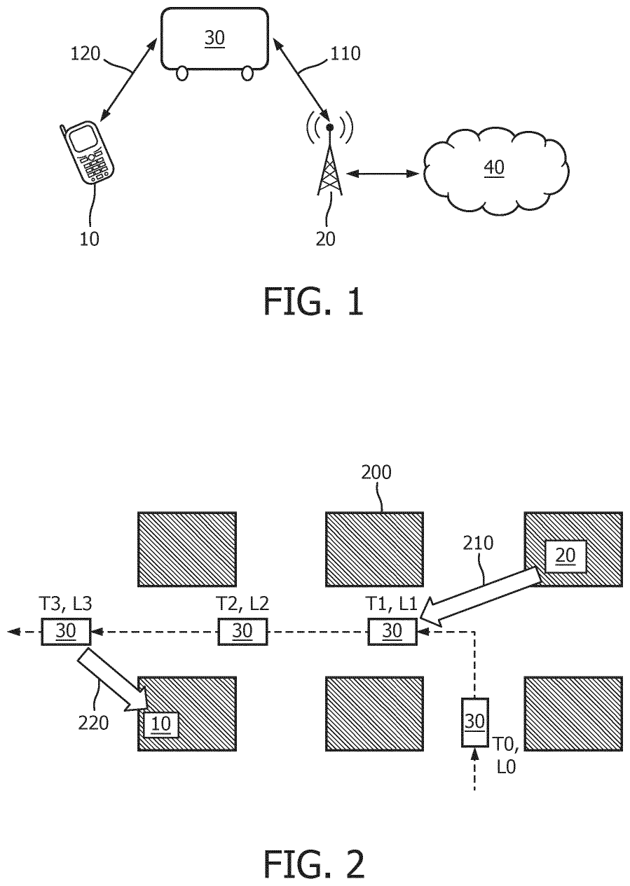

FIG. 1 schematically shows an architecture of a cellular network in which the present invention can be implemented.

In the architecture of FIG. 1, a mobile access device 30 is provided for relaying data between a donor access device (e.g. gNB) 20 (i.e. macro access device) and a terminal device (e.g. wireless communication device such as a UE) 10. The donor access device 20 provides connectivity to a 5G core network 40.

In an example, the mobile access device 30 may be a vehicle-mounted relay which can be defined as a mobile base station that serves terminal devices (e.g. UEs) that are in the vehicle or close to the vehicle. The vehicle-mounted relay might also host and implement some network functions to deliver the communication services mentioned in various embodiments.

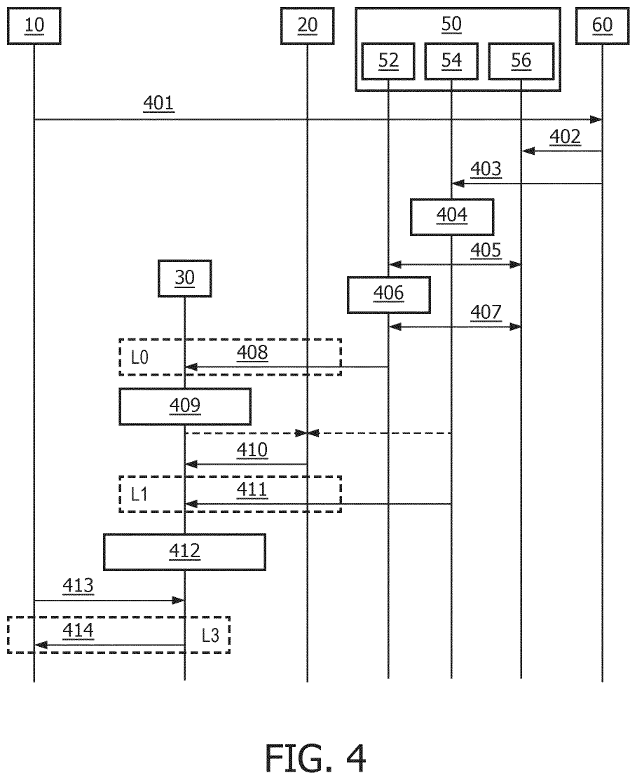

The mobile access device 30 may be connectable through a first wireless link 110 to the donor access device 20 and through a second wireless link 120 to the terminal device 10 (e.g. as described in FIG. 4-1 of 3GPP specification TR_22839).

It is noted that functionalities of the mobile access device 30 to realize use cases of the following embodiments may go beyond the functionalities implemented in a conventional static access device (e.g. gNBs). In particular, the mobile access device 30 may require implementation of some network functions such as an intermediate user plane function (I-UPF) or a local application function (AF). It might also require hosting of an edge computing application or an edge application server.

According to various embodiments, use cases and protocol flows are described, in which 5G systems or other wireless networks deliver better download capability for terminal devices. This can be achieved by using the mobile access device 30 between the terminal device 10 and the macro (donor) access device 20 to optimize at least one of mobility and network topology, transfer of data by caching it at the mobile access device 30, and allocation of communication parameters between the terminal device 10 and the mobile access device 30 and/or between the mobile access device 30 and the macro access device 20.

Where the above optimization is based on positioning information of the mobile access device 30, the communication may be prepared in advance in such a way that data communication (e.g. video call) is not affected, the download of a related file is put on hold in the macro cell since it is currently overloaded, the mobile access device (relay station) 30 starts caching the download of the requested data by the terminal device 10, and the terminal device 10 and mobile access device 30 are made aware of their positions/trajectories to adapt and plan their radio access network (RAN) communication settings.

In examples, data downloads may be coordinated over mobile base stations to improve communication performance in wireless networks such as 5G. To achieve this, a RAN protocol may be adapted for optimized mobility, which may include handover protocols or modifications in an integrated access and backhaul (IAB) e.g. for multi-hop backhauling based on a mobility pattern of the mobile access device 30.

In other examples, protocols for planned data downloads may include a dynamic setup of an edge server or data caching at the mobile access device 30.

In further examples, RAN connectivity between the terminal device 10 e.g., a static terminal device, and the mobile access device 30 and/or between the mobile access device 30 and its macro cell may be optimized based on knowledge of the positioning information of the mobile access device 30.

In still further examples, vehicles with onboard base stations, so called mobile base stations (MBS), may be configured to act as relays and help provide efficient data delivery. This use case addresses the needs of users who are not moving with the mobile base station but can benefit from connectivity offered by an MBS when users and mobile base stations are close by. In particular, this use case addresses the needs of those terminal devices (e.g. UEs) that either have limited connectivity (e.g., when connected to a macro cell) or that have too demanding bandwidth needs.

FIG. 2 schematically shows an example of a planned data download to an off-board terminal device from a mobile base station.

In FIG. 2, a city environment where each hatched square corresponds to a block 200 of houses. A fixed gNB 20 acts as donor gNB and a UE 10 is shown two blocks away from the donor gNB 20 in a position with bad connectivity. Furthermore, a mobile gNB 30 and its route (bold dotted arrow) is shown. The route includes locations L0 to L3 at times T0 to T3. At location L1 and time T1, the mobile gNB 30 receives a first data transfer 210 from the donor gNB 20 that is “relayed” to the UE 10 at location L3 at time T3 by a second data transfer 220 to the UE 10.

For instance, a user, Tom, is waiting for bus number 23. While doing so, Tom is watching his preferred series of a video streaming service via his UE 10. He is also having a call with a friend. However, Tom's network connectivity at his current location is insufficient, in particular, to handle the video streaming service, since the donor gNB 20 is far away from his UE 10. In this example, it is beneficial if the UE 10 can request the download of the series and schedule their delivery through a suitable mobile relay in the vicinity of the user, e.g., bus number 45 that is arriving at the bus stop in a few instants. The data transfer 220 from bus number 45 with mobile base station (gNB) 30 to UE 10 is performed at time T3 and location L3.

The above example may require as pre-conditions that the mobile network operator (MNO) operates mobile base stations and macro cells in a city, the user, Tom, has a UE and is subscribed to the MNO, is connected to a macro base station (not shown in FIG. 2) and needs to retrieve certain files (e.g., a movie or websites).

The proposed data transfers 210 and 220 may involve the following service flows:
The UE 10 of the user is connected to the (5G) macro network;
the (5G) macro network is capable of delivering his normal communication needs, in particular, low latency and low bandwidth communication needs but offers limited capacity for the download of large amounts of data due to spotty coverage and a high number of UEs;
the MNO operates mobile base stations that offer extra additional capacity and the mobile network determines that the download needs of our user Tom can be fulfilled by mobile base station (gNB) 30, bus number 45, approaching Tom's location;
the 5G system caches Tom's required downlink traffic at the mobile base station (gNB) 30 that is approaching Tom's location, wherein downloading of this data to the mobile base station (gNB) 30 can be done very fast since this is done at time T1 and location L1 when the mobile base station (gNB) 30 is very close to the macro base station (gNB) 20;
when the mobile base station (gNB) 30 is then close to Tom's UE 10 at time T3 and location L3, the UE 10 connects to the mobile base station (gNB) 30 and the UE 10 rapidly receives all requested data; and
when the mobile base station (gNB) 30 moves away, Tom's UE 10 releases its connection with the mobile base station (gNB) 30.

As a result, the user can enjoy a fast downlink connection and retrieve all his required files without affecting his call.

To achieve this, the cellular (5G) system provides at least one of a means to schedule and cache data download at mobile base stations, a means to optimize mobility between macro and mobile base stations required to deliver fast data download, or a means to plan and optimize RAN communication between a terminal device (e.g. UE) and a mobile base station before the terminal device and the mobile base station are connected.

In another example, a user, Tom, is an emergency physician who just arrived at a car accident. Tom is attending several injured persons. Tom is having a call with other clinicians at a close-by hospital discussing the health state of the patients and to which hospital the patients should be transferred. Tom would also like to retrieve the Electronic Health Record of the patients to do a better assessment. However, the network connectivity at his current location—the accident area—is insufficient, in particular, to download some bulkier files in the EHR of the patients. In this situation, it is beneficial if Tom's UE could schedule the download of the EHR. This could be done by means of a relay mounted on one of the ambulances that are already approaching the accident area. This example can also be illustrated by means of FIG. 2. At location L0 and time TO the EHR data transfer is requested by the UE. The mobile base station, an ambulance-mounted relay (AMR), receives the EHR data from the macro cell at location L1 and time T1. The AMR caches this EHR data. When the AMR is at location L3 at time T3, the AMR can rapidly deliver the requested EHR data to Tom's UE. In an alternative example, the terminal device may be an IoT device requiring delivery of a software update. Some IoT devices might lack continuous connectivity to the macro cell, but the IoT devices might be able to retrieve the software update from the mobile base station (gNB), when it is close by. In an alternative example, the mobile base station may be an unmanned aerial vehicle (UAV) or a satellite.

In these related examples and embodiments, a UE, e.g., an IoT device, can be configured with a wake-up schedule that corresponds to the mobility pattern of the mobile base station. Alternatively, the mobile base station is configured with a mobility pattern that fits the wake-up schedule of the UE, e.g., IoT device. It is also possible to design the mobility pattern and the wake-up schedule to complement each other.

In an embodiment, a managing entity, e.g., a network function in the core network, or the donor gNB having access to the mobility pattern of at least one mobile base station will use and/or retrieve the identity and location of one or more UEs, e.g., from another network function such as the AMF, and set a wake-up schedule for the UE that fits this mobility pattern, i.e., the UE will be configured to wake up when the mobile base station is close. The managing entity might have access to all information (mobility pattern, identity and location of UEs, etc) e.g., stored in a data base or might need to request the data from other managing entities or network functions in a network. The wake-up schedule should be such that is capable of dealing with potential time differences in the arrival time of the mobile base station, e.g., being awake before and after the expected arrival time. This can be a configurable parameter.

In an embodiment, if UEs are located following a given distribution, e.g., a line as the smart meters in a row of houses next to street or the lighting lamps next to the street, UEs might also communicate with each other, e.g., over the PC5 interface, to get an indication of the arrival time of the mobile base station from other UEs or to notify other UEs about the arrival time. For instance, if the mobile base station is supposed to reach UE1 at 14:00 and UE2 at 14.02 and UE1 is configured to wake up at 13.59 and remain awake for 2 minutes and UE2 is configured to wake up at 14.01 and remain awake for 2 minutes and the mobile base station arrives with certain delay at UE1, e.g., at 14:00:30, the UE1 might exchange over a communication interface (e.g., the PC5 interface) information related to the arrival (e.g., on time, late, early, . . . ) of the mobile base station so that the second UE can take it into account, e.g., by going to sleep till the actual arrival of the mobile base station.

In an embodiment, the mobility pattern of a mobile base station might be influenced by the wake-up schedule of at least UE. In this case, a network function in the core network, or the donor gNB having access to the wake-up schedule of one or more UEs might determine the mobility pattern of the mobile base station (e.g., a drone or a vehicle) and configure accordingly such a mobility pattern.

In an embodiment, a UE requiring access to a given resource, e.g., a software update or an app update, might announce in advance its requirements to a managing entity, e.g., a network function or a base station. The managing entity can subscribe to the corresponding resource updates on behalf of the UE. The managing entity will retrieve or get notified of such updates and make them available at the mobile base station. The UE can then retrieve or receive the updates from the mobile base station, e.g., when the UE wakes up and/or the mobile base station is close.

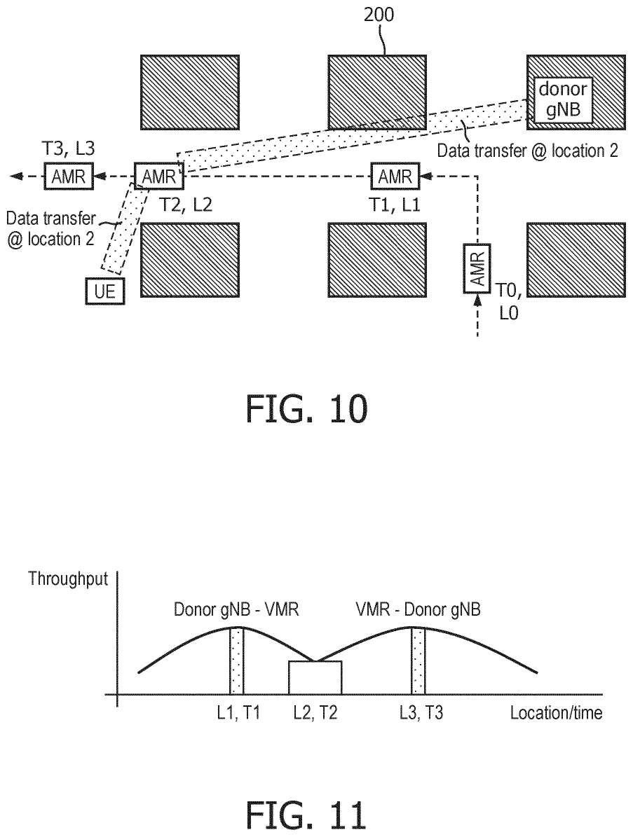

FIG. 10, similar to FIG. 2, schematically shows an example of a planned data download to an off-board terminal device through a mobile base station from a donor gNB. In FIG. 10, we observe that at location L0 and time TO the EHR data transfer is requested by the UE. This point of time might also represent application knowledge knowing or predicting that a UE will consume or send certain data. In this case, the data is transferred end to end from donor gNB to UE at location L2 and time T2. Location L2 is chosen to optimize the end-to-end connectivity from donor gNB to UE over an Ambulance Mounted Relay (AMR). This optimization can be done based on the knowledge of historical or predicted throughput curves between UE and AMR and between AMR and donor gNB. This predicted throughput is shown in FIG. 11, where we observe that L2 is the location with the best possible end-to-end communication link in the path of the AMR. Note that L2 does not offer a throughput as good as the individual communication links at location L1 (AMR-donor gNB) and location L3 (UE-AMR).

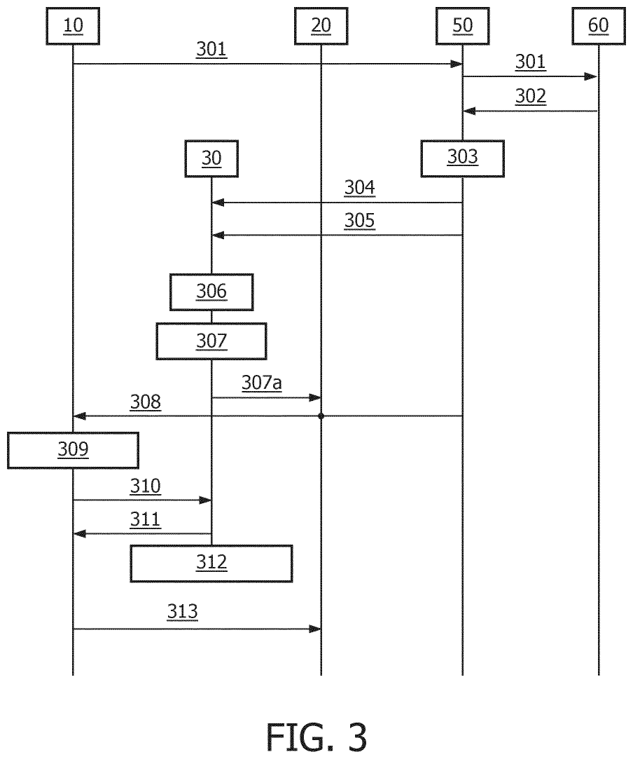

FIG. 3 schematically shows a signaling and processing diagram for the planned data download of the example shown in FIG. 2. Involved devices are a UE 10, a macro base station (gNB) 20, a CN 50, a domain name server (DN) 60 and a mobile base station (gNB) 30.

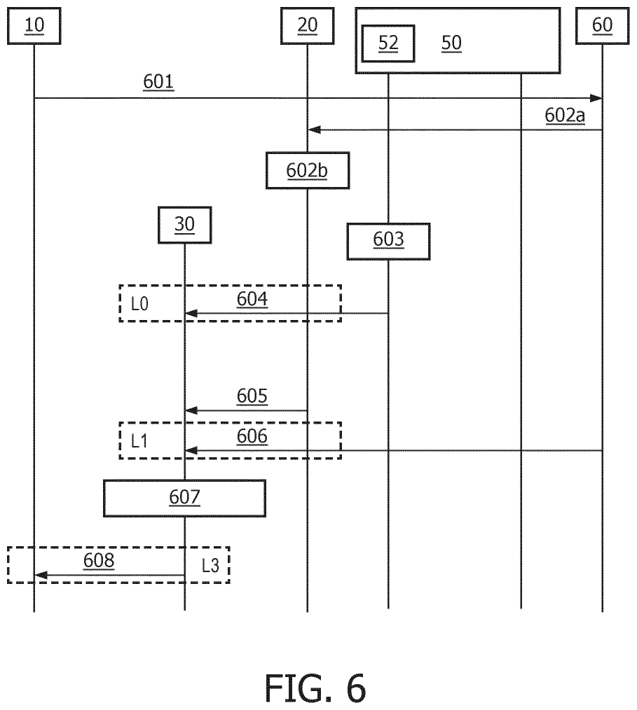

In the signaling and processing sequence of FIG. 3 and the signaling and processing sequences of subsequent FIGS. 4 and 6, the vertical direction from the top to the bottom corresponds to the time axis, so that messages or processing steps shown above other messages or processing steps occur at an earlier time.

In step 301, the UE 10 announces bandwidth/processing needs. This can be notified to the CN 50 or the UE 10 might notify a third-party application at a given data network. For instance, the UE 10 can announce that it requires the download of a specific data file. This information can be extracted from high application layers or the request can be provided directly to the application provider. For instance, if the user is willing to watch a 2 h-long movie in a streaming service (e.g. a content platform (CP)) the UE 10 can expect that the whole data file will need to be streamed in the next 2 hours. This is data that needs to be delivered from the streaming service through the mobile network (i.e. CN 50 and RAN).

It is noted that the CN 50, DN 60 and streaming application can also predict the behavior of the user and his needs. For instance, if a user watches an episode of a television (TV) series every evening, the DN 60 can identify the communication needs of the user. This might also apply to users who commute, since some of those users usually consume some data resources in a predictable way, e.g., watch such TV series during their commuting times and communication needs can thus be predicted based on their commuting behavior. If the DN 60 knows the requirements of the user and the CN 50 is aware of the mobility pattern of the user, then the cooperation between the DN 60 and the CN 50 can allow placing the requested resources at the right place and time so that the user can efficiently consume them.

In step 302, the DN 60 makes a request for the CN 50 to allocate resources for delivery of the data to the UE 10. This can be an action taken on demand for a specific user and data request. Alternatively, this can be an initial configuration step in which the DN 60 and CN 50 agree to deliver data to users in an optimized manner. Based on this agreement, the CN 50 can allocate resources and move the application/data in such a way that it is efficiently delivered to the end user, for instance, it might place the application/data close to the UE, e.g., in an edge server close to the donor gNB 20.

In step 303, the CN 50 knows the route of mobile base stations as well as the location of the user and his macro cell. The CN 50 plans which of the mobile base stations will be in close vicinity of the user taking into account their current schedules. Based thereon, the CN 50 can identify which mobile base station can deliver which load to which UE taking into account at least one of the positions of each UE at time t, the positions of each mobile base station at time t, and the communication requirements of a user at time t.

A simple exemplary strategy may consist in checking which mobile base station is going to be close to the UE 10 next, and whether the available communication link between the UE 10 and a potential mobile base station will be enough to handle the communication requirements of the UE 10. The available communication link refers to the available communication resources when the UE 10 and the potential mobile base station encounter taking into account the distance and expected duration of the communication link.

In step 304, the CN 50 informs a chosen mobile base station 30 about a presence of a user along the route of the mobile base station 30, data requirements of the user of the UE 10, and/or the position of the UE 10, so that the mobile base station 30 can pre-optimize transmission parameters, e.g., beamforming or frequency or pre-allocate transmission resources.

In step 305, the CN 50 allocates resources at the mobile base station 30, e.g., triggered by the DN request. These resources can be storage resources to cache the data transfer or communication resources to perform the data transfer. The CN 50 starts a local download of the resources required by the user to the mobile base station 30 (e.g. caching, as in a content delivery network).

In step 306, data caching or local storage might be performed at the mobile base station 30.

In step 307, the mobile base station 30 pre-allocates and configures communication resources for the transmission of the requested data taking into account at least one of the required amount of data to transfer, the known position of the user, the expected trajectory of the mobile base station 30 and expected time during which the UE 10 and the mobile base station 30 will be in a predetermined range.

These communication resources might include coding (e.g. scrambling code, channelization code), timing and frequency resources and/or beam forming over time. Some of these parameters can be configured in advance since the mobile base station 30 has knowledge of the positioning information of the mobile base station 30 and historical data related to, e.g., a reported channel quality indication (CQI). Parameters such as beam forming can be optimized and pre-configured since the position of the UE 10 may be known (in some cases, it can be assumed to be static) and the trajectory of the mobile base station 30 may also be known.

In step 307a, for efficiency purposes, the allocation of the communication resources for the mobile base station 30 may be done through the macro cell (i.e. macro base station 20), i.e., before the mobile base station 30 is in the predetermined range and the UE 10 is connected to it, or a handover procedure has even started. Similarly, the UE 10 may be informed of the mobile base station 30 through the macro cell, e.g., in the context of a conditional handover (CHO) including conditions required for joining and leaving the mobile base station.

In step 308, the CN 50 can inform the UE 10—through the macro cell (i.e. macro base station 20)—about the timing when the mobile base station 30 will be in reach and available for delivery. Optionally, the CN 50 may also inform the UE 10 about the physical cell identifier and beam index to use to speed up cell acquisition. As another option, the CN 50 may provide handover parameters and transmission parameters for the mobile base station 30. If system information (e.g. master information block (MIB), system information block 1 (SIB1)) broadcasted by the mobile base station 30 is signed, the CN 50 can provide the UE 10 with this information through the macro cell as well, so that the information can be pre-verified.

In step 309, the UE 10 may schedule the handover in advance. The UE 10 may also receive communication parameters in advance. This may include, e.g., beam forming parameters since the UE 10 is aware of the expected trajectory of the mobile base station 30.

In step 310, when the mobile base station 30 appears according to the schedule, the UE 10 connects to the mobile base station 30. In some circumstances, the UE 10 may also request the required resources (data) again, triggering then the local download, e.g, from the mobile base station 30 or from an edge server, e.g., collocated with the donor gNB 20. In some circumstances, the data had already been requested, and it will be directly downloaded, as soon as the UE 10 and the mobile base station 30 are connected.

In step 311, once the UE 10 and the mobile base station 30 are connected to each other, data transfer can occur with minimal latency since communication parameters have been preconfigured and the UE 10 is able to download data directly from the mobile base station 30 or a close edge server, e.g., collocated with the donor gNB, that has been caching the data when approaching the UE 10.

In step 312 the cached data may be removed at the mobile base station 30 or close by edge server.

Finally, in step 313, once the exchange of the bulky data is finished, the UE 10 reconnects to its previous macro cell (i.e. macro base station 20), when the UE 10 has dropped its connection.

More generally, steps 308-313 can define a method for performing a conditional handover between a first communication device (e.g., a UE) and a second communication device (e.g., a donor cell/macro base station) and a third communication device (e.g., a mobile base station) based on at least the mobility pattern of the third communication device wherein the first communication device moves from the second communication device to the third communication device and then back to the second communication device. Such a method can be used independently from (as well as in combination with) the other methods and examples given throughout the description of this embodiment.

Similarly, a first device (e.g., a UE) can be configured to perform a conditional handover from a second communication device (e.g., a donor cell/macro base station) to a third communication device (e.g., a mobile base station) device and then back to the second communication device based on at least the mobility pattern of the third communication device as set out in steps 308-313.

Similarly, a second communication device (e.g., a donor cell/macro base station) can be configured to manage the conditional handover of a first communication device (e.g.,) to a third communication device (e.g., a mobile base station) device and then back to the second communication device based on at least the mobility pattern of the third communication device as set out in steps 308-313.

Besides, in more general terms, step 306 in the context of Steps 307-313 defines a method that includes the step of caching data at the third communication device to efficiently exchange data with the first communication when the communication link between the first communication device and the third communication device is suitable based on the mobility pattern of the third communication device. Such a method can be used independently from (as well as in combination with) the other methods and examples given throughout the description of this embodiment.

Similarly, a second communication device (e.g., a donor cell/macro base station) can be configured to forward data for a first communication device (e.g., a UE) towards a third communication device for the purpose of caching the received data till the communication link between the first communication device and the third communication device is suitable based on the mobility pattern of the third communication device, as set out in Step 306 in the context of Steps 307-313.

Similarly, a third communication device can be configured to receive data from a second communication device (e.g., a donor cell/macro base station) wherein data is for a first communication device (e.g., a UE), wherein the third communication device includes a memory adapted to cache the received data till the communication link between the first communication device and the third communication device is suitable based on the mobility pattern of the third communication device, as set out in Step 306 in the context of Steps 307-313.

It is noted that this embodiment may also be applicable to satellite and unmanned area vehicle (UAV) scenarios, if they are to provide connectivity to terrestrial UEs or UE access points (APs).

Thus, optimized mobility is provided to make sure that data can be transferred fast between a macro cell and a mobile base station and the mobile base station and a terminal device. Optimizing mobility can be achieved at multiple levels within the RAN. One of them refers to the handover procedure. Another option may be a multiple-hop communication UE—mobile base station—macro cell.

Regarding the handover (HO) procedure, this procedure can be optimized by making use of a mobility pattern. The optimized handover procedure that builds on a CHO may be based on at least one of the following options:

a) The request for CHO might not be triggered by the UE but by the CN itself, e.g., access and mobility management function (AMF) or session management function (SMF) in 5G networks, once the CN has determined which mobile base station will be the most suitable one for the data delivery. This might be required since the CN is aware of the route of the mobile base station and can plan the handover.

b) If the UE sends a radio resource control (RRC) measurement report triggering the CHO request, the donor gNB (macro base station) might not be aware of which mobile base station is approaching. To address this issue, the fixed base stations (macro cells) along the route of the mobile base station could be configured with the schedule of the mobile base stations. This can be a one-time configuration step. Similarly, the mobile base stations could be informed about the macro cells accordingly by the CN.

c) Alternative to option b, the macro cell might forward the request from the UE to the CN so that the CN sends input to the macro cell—on demand—about the mobile base stations that might be suitable to handle the connection requested by the UE. This may involve that that the mobile base stations send updates on their route to the CN so that the CN is aware of it.

d) Alternative to option c, the request sent by the UE to trigger CHO might be sent directly to the CN.

e) The RRC reconfiguration message returned by the mobile base station might include at least one of: the fact that it is a mobile base station, the mobile base station's positioning information (over time) so that UE can take this information into account, connection parameters for multiple instants of time due to the changing position of the mobile base station (these connection parameters can be made available if the macro cell informs the mobile base station about the location of the UE), and configured grant parameters for uplink (ConfiguredGrantConfig including the parameter rrc-ConfiguredUplinkGran) and semi-persistent scheduling (SPS) for downlink based on pre-configured/predicted communication parameters.

f) The RRC reconfiguration may be sent by the mobile base station to the donor gNB (macro base station) when requested by the CN, e.g., AMF.

g) The cell switch conditions delivered to the UE in the CHO configuration message may include at least one of the physical cell identity (PCI) of the mobile base station (gNB) when the mobile base station is close to the UE while considering that the mobile base station might use multiple PCIs to avoid collisions when they are moving, the timing at which the mobile base station is predicted to be in communication range taking into account its positioning information (e.g., current location, speed, acceleration, rotation, . . . ), and the timing at which the mobile base station is predicted to be outside of communication range taking into account its positioning information (e.g., current location and speed).

h) The UE may join a mobile base station if it fulfils the conditions, e.g., if it is going to be in close vicinity long enough and is capable of delivering the required connectivity.

The above proposed options for CHO optimized for vehicle-mounted relays may be applied to other use cases, e.g. as described in 3GPP specification TR 22.839, independently of the main use case described in the embodiments. For instance, this can apply to use cases in which it is desired to optimize the upload of data from the UE towards the CN.

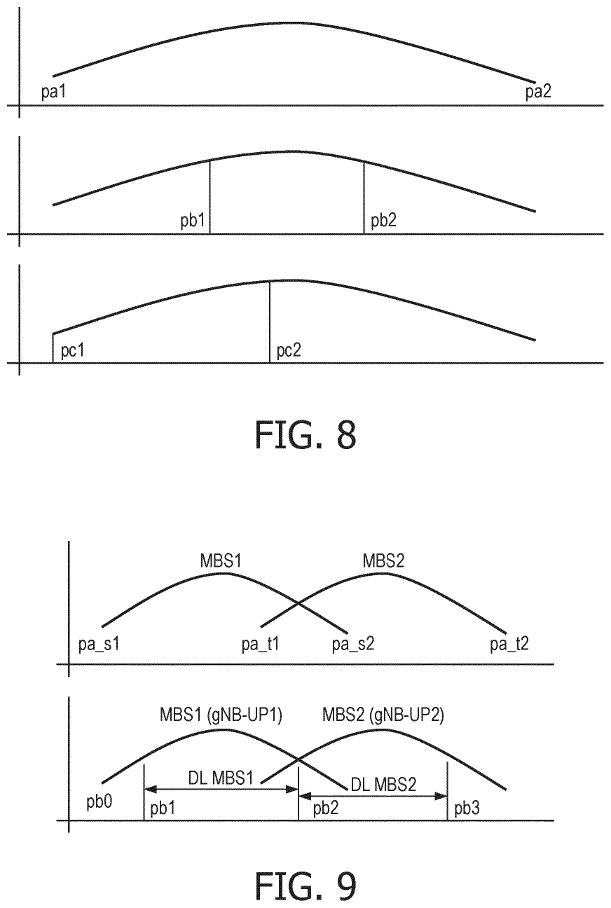

Another option for HO optimization is if the mobile base station (gNB) and the macro base station (gNB) are instances of a split between a central unit (CU) and a distributed unit (DU). In this case, the mobile base station and macro base station may not be two fully independent base stations. The macro base station may include the CU of the mobile base station and a fixed DU. The mobile base station (relay) may be a DU of the macro base station. Then, the optimized handover may refer to a decision of the CU about which DU should be used when delivering a given communication link to a UE. Each DU might support multiple cells and each cell might support multiple beams. In this case, GPRS tunneling protocol user data (GTP-U) tunnels may be used to connect with the user plane function (UPF) through an N3 interface. This handover can be done by means of the DU/CU split architecture as described e.g. in 3GPP TS 38.401 Section 8.2. However, some of those procedures can be optimized for mobile base stations (gNBs) taking into account the positioning information of mobile base stations. As an example, Figure 8.2.1.1-1 in TS 38.401 shows how inter-gNB DU mobility for intra-NR is performed. In this case, the source gNB-DU may report a measurement report from the UE to the CU that will send the request for context setup to the target DU. The target DU may then send a response to acknowledge the setup of the UE context. Then, the CU sends a request to the source DU to modify the UE context. As a consequence, the source DU sends an RRCConnectionReconfiguration to the UE and delivers the current status of the downlink data delivery to the CU and confirms the modification of the UE context. Next, the UE can perform a random access procedure with the target DU till the UE sends RRCConnectionReconfigurationComplete to the target DU, that will be forwarded to the CU. Simultaneously, the CU may send the downlink user data to the target DU that is delivered to the UE. The target DU can also start receiving uplink user data.

This protocol can benefit from knowledge of the positioning information (location, velocity vector, etc.) of a mobile DU (i.e. the mobile base station) since it can be estimated when a UE is going to send a given measurement report triggering the handover. It can also be predicted which DU is going to be the target gNB. With this knowledge it is possible to improve the data distribution performance as follows:

a) By sending an RRCConnectionReconfiguration message from the CU to the UE including the timing and conditions for moving from the source DU to the target DU, the UE can directly perform the random-access procedure with the target DU without having to wait for the RRCConnectionReconfiguration.

b) By including information in the random-access procedure and/or RRCConnectionReconfigurationComplete message sent by the UE to the target DU about the downlink data delivery status, the target DU can choose the downlink user data to start transmitting.

c) By caching downlink user data at the target DU in advance. The caching of the downlink data might involve collocating the UPF with the gNB since the UPF has the capabilities to buffer downlink data steered by the SMF.

In an exemplary embodiment, the usage of above handover-related examples and options are illustrated in the context of the conditional handover procedure described in Clause 9.2.3 in TS 38.300. Regarding the general conditions in Clause 9.2.3.4.1 the following additions/modifications could be considered, either individually or in combination:
(1) the execution conditions might have been generated by the donor gNB and/or the core network;
(2) the execution condition might include the mobility pattern (position, speed, acceleration, schedule, route etc) of the mobile base station and/or external factors/data affecting the position of the VMR (e.g., traffic lights status, congestion);
(3) while executing the CHO, the UE might have to keep monitoring the source cell, in particular for the case in which the UE (e.g., a UE outside of the mobile base station) has to perform a subsequent handover back to the original source cell; in general, a UE might need to keep monitoring a list of cells that are expected to provide connectivity to the UE based on the mobility pattern of the cells.

More generally, it can be proposed a method for enabling the handover of a first communication device (e.g., a UE) from a second communication device (e.g., source cell or donor gNB) to at least a third communication device (e.g., target cell or mobile base station) whereby
the execution conditions may have been generated by the second communication device and/or the core network, and/or
the execution conditions may include the mobility pattern (position, speed, acceleration, schedule, route etc) of the third communication device and/or external factors/data affecting the position of the third communication device (e.g., traffic lights status, congestion), and/or
   the first communication device may need to keep monitoring the second communication device and/or a third communication device that is expected to provide connectivity to the UE based on the mobility pattern of the third communication device. Similarly, it is proposed a first communication device that keeps monitoring the second communication device once a handover towards the third communication device based on the mobility pattern of the third communication device has been executed.

Similarly, it is proposed a second communication device that is adapted to generate alone and/or in coordination with the core network execution conditions for a handover of a first communication device to and/or back from a third communication based on the mobility pattern of the third communication wherein the execution conditions may include the mobility pattern (position, speed, acceleration, schedule, route etc) of the third communication device and/or external factors/data affecting the position of the third communication device (e.g., traffic lights status, congestion). These aspects could be implemented independently from the other embodiments herein described or could be proposed as additional option combined with one or more of the described embodiments, variants and/or example herein described.

Regarding the C-plane handling in Clause 9.2.3.4.2, the following additions/modifications may be considered, either individually or in combination: (1) the preparation and execution of the CHO (Conditional Handover) might require involvement of the 5GC since the 5GC has knowledge of the location/speed/acceleration (in general, mobility pattern) of the mobile base station as well as other factors (e.g., traffic lights, traffic jam, . . . ) affecting the location/speed/acceleration of the mobile base station, in particular, the AMF might provide information about the source gNB (e.g., donor gNB or a first mobile base station) and target gNB (e.g., a second mobile base station) involved in e.g., a mobility scenario (UE—donor gNB)→(UE—mobile base station)→(UE—donor gNB). Here, A-B means that A is connected to B and (A-B)→(A-C) means that A is connected first to B and performs handover to connect to C. In such a mobility scenario or others involving several subsequent handovers triggered by the mobility pattern of the cells, the source gNB or donor gNB or gNB-CU can schedule a handover, e.g., a CHO involving a first handover from source gNB to target gNB (mobile base station) and a second handover from target gNB (mobile base station) to source gNB, and so on when more mobile base stations are involved; (2) related to Figure 9.2.3.4.2.1-1 step 0, the AMF might provide information regarding the mobility pattern and external factors related to mobile base stations to the source gNB that might, e.g., play the role of donor gNB; (3) related to Figure 9.2.3.4.2.1-1 steps 1 and 2, the source gNB based on the location and measurements of the UE might decide to provide connectivity to the UE via a target gNB that will be close to the UE and is expected to provide overall a better communication link; (4) related to Figure 9.2.3.4.2.1-1 steps 3-5, the source gNB coordinates with the target gNB (mobile base station); (5) related to Figure 9.2.3.4.2.1-1 steps 6 and 7, the source gNB informs the UE about the approaching target gNB and conditions for connecting to it including the target location of the target gNB (where the location might be broadcasted by the mobile base station/target gNB) and furthermore, the source gNB can also inform the UE about the conditions to subsequently connecting back to the source gNB (or another target gNB) and furthermore the source gNB can inform the UE about information required to access the target cell, e.g., the target cell ID and/or a new C-RNTI and/or the target gNB security algorithm identifiers for the selected security algorithms and/or dedicated RACH resources and/or the association between RACH resources and SSB(s) and/or the association between RACH resources and UE-specific CSI-RS configuration(s) and/or common RACH resources, and system information of the target cell and/or specific beam configuration; (6) related to Figure 9.2.3.4.2.1-1 step CHO conditions evaluation and detach, in the case of a CHO related to mobile base stations and a UE outside of the mobile base station, the UE might not be required to fully detach from the old cell.

Before, while, and after handover is performed, the U-Plane Handling (related to Clause 9.2.3.2.2 in TS 38.300) might involve several additions/modifications that might be applicable individually or in combination: (1) user data might be forwarded from the source gNB (e.g., donor gNB) to the target gNB (mobile base station) already before HO execution, in general, a method is provided that allows a second communication device (e.g., source gNB or donor gNB) to forward data to a third communication device (e.g., target gNB or mobile base station) before handover is executed with a first communication device (e.g., a UE); similarly, a (second communication) device is provided that forwards data to a third communication device (e.g., target gNB or mobile base station) before handover is executed with a first communication device (e.g., a UE); (2) the target gNB might not send a path switch request to the AMF since it is expected to perform a handover back to the original source gNB, in general, a method is provided that allows the third communication device to keep delivering data to the first communication device that has been forwarded by the second communication device without requiring to send a message to a fourth communication device (e.g., AMF) indicating the completion of the handover of the first communication device from the second to the third communication devices; (3) the user data can be forwarded to the target gNB (mobile base station) so that it is cached for efficient delivery as soon as the UE is connected to the target gNB, in general, a method is described that allows the third communication to cache the forwarded data for the first communication device and deliver it once the first and third communication devices are connected; (4) the target gNB might send a path switch request message to the AMF before the UE has completed the handover to inform that the UE is going to gain access and the AMF then triggers path switch related 5GC internal signaling and actual path switch of the source gNB to the target gNB in UPF, in general, a method is provided that allows the third communication device to send a message to a fourth communication device (e.g., AMF) indicating the foreseen completion of a handover procedure of the first communication device from the second to the third communication devices so that the fourth communication device can indicate to a fifth communication device (UPF) that the data addressed to the first communication device should be sent to the third communication device; (5) alternatively, an I-UPF might be activated as illustrated in some embodiments, in general, a method is provided that allows the third communication device to send a message to a fourth communication device (e.g., AMF) indicating the foreseen completion of a handover procedure of the first communication device from the second to the third communication devices so that the fourth communication device can directly or indirectly activate a fifth communication device (I-UPF) that might be collocated with the third communication device; (6) the source gNB (e.g., donor gNB) might remain responsible for allocating downlink PDCP SNs even after the source gNB receives the HANDOVER SUCCESS message or the handover to the target gNB (e.g., mobile base station) is completed, this applies in particular in the case of a mobility scenario (UE-donor gNB)→(UE-mobile base station)→(UE—donor gNB); (7) for security synchronization, HFN is maintained for the forwarded downlink SDUs with PDCP SNs assigned by the source gNB, this applies in particular in the case of a mobility scenario (UE—donor gNB)→(UE—mobile base station)→(UE—donor gNB); (8) during and/or after the handover execution period, the target gNB (mobile base station) does not perform ROHC header compression, ciphering, and adding PDCP header, only the source gNB is in charge of these operations, in general, a method is described that allows a second communication device to manage communication parameters used when communicating with the first communication device once the first communication device has completed a first handover with a third communication device and the first communication device only processes the data received from the third communication based on the communication parameters managed by the second communication device; (9) the establishment of a forwarding tunnel in the uplink communication is mandatory; (10) the HFN and PDCP SN are maintained in the source gNB (donor gNB).

In an embodiment that might be combined with other embodiments, the mobile base station is realized by means of an RF repeater, e.g., a smart RF repeater or reflective intelligent surface, mounted on a vehicle that allows for efficient communication between a UE and a donor gNB. The donor gNB is in charge of controlling the communication parameters of the RF repeater based on e.g., the mobility pattern of the vehicle or measurements reported by the UE related to the received signal through the RF repeater. When the donor gNB measures a suitable communication link with the UE through the RF repeater, the donor gNB will transmit/receive data to/from the UE through the RF repeater mounted on the vehicle while the donor gNB controls its communication parameters (e.g., beam forming) to keep tracking the RF repeater and controls the communication parameters of the RF repeater so that the communication parameters (e.g., beam forming) of the RF repeater are aligned with the UE and donor gNB based on the mobility pattern of the vehicle including measurements/information from the RF repeater mounted on the vehicle reported to the donor gNB related to its (e.g., current/real-time/future) mobility pattern.

The above proposed capabilities may not only apply not only to the main use case in the above embodiment, but also to other use cases, e.g., as described in 3GPP TR 22.839. For instance, this can apply to use cases in which it is desired to optimize the upload of data from the UE towards the CN.

In other embodiments, integrated access and backhaul (IAB) aspects may be considered for mobility optimization. Section 6.1.3 in 3GPP TS 38.401 describes the IAB architecture. Section 6.1.4 describes the protocol stacks for IAB. From an IAB point of view, the mobile base station can be a DU that connects to a parent DU that plays the role of an IAB donor base station (gNB). A mobile base station might also connect to multiple parent DUs under a same IAB gNB donor or to multiple IAB gNB donors when it changes its position. There are multiple challenges for IAB in the context of mobile relays, one of them is that the IAB communication parameters such as L2 identifiers, IP addresses or routing tables will be less static because of the mobile nature of the mobile base stations. In fact, the current TR 22.839 prefers a limitation in the number of hops to a single hop. But even in this case, if a mobile base station keeps moving, then when it moves out of range of its current parent node and gets close to another base station (potential parent node), the mobile base station may need to register again.

In embodiments, it is determined that a mobile base station will come close to multiple macro base stations or IAB nodes. For mobile base stations following the same route in a periodic manner, or in general, just a known route, an optimization may consist in advertising or communicating that it is such a mobile base station and including its route timing. The IAB donor CU/DU may consider this fact to create communication parameters such as routing information that is dependent on the mobility information of the mobile base station. When the mobile base station is in the vicinity of the IAB donor CU/DU, that communication parameters can be (re-) activated. If the mobile base station is out of range, the communication parameters for the mobile base stations may be put on hold by the IAB donor CU/DU and a different IAB configuration may be applied. This approach can be done at multiple levels.

For instance, in an embodiment, if the mobile base station moves under a different DU controlled by the same gNB-CU, the F1 interface (inter-connection between gNB-CU and gNB-DU) can remain active, and only the backhaul adaptation protocol (BAP) routing tables may need to be updated taking into account that the mobile base station moved away from an old DU to a new DU. In this case, the BAP routing tables can contain entries that can be active or inactive depending on the presence of the mobile base station. A parent node migration/topology adaptation strategy may be improved as follows when dealing with mobile base stations:
When the mobile base station requests to release a backhaul (BH) link (with the old parent IAB), the BH link and BAP layer route are not released but made dormant so that they can be reestablished later faster.
When the mobile base station requests to establish a BH link (with the new parent IAB), the BH link and BAP layer route are established if not available or are reactivated if available from a previous connection.

More generally, under this embodiment, it is proposed a method for reducing the (re-) configuration overhead at a first communication device (e.g., donor gNB or first mobile base station) and a second communication device (e.g., a second mobile base station) by storing on both the first and second communication devices a set of IAB communication parameters such as BAP entries and/or IP addresses and/or L2 parameters and/or F1 interfaces that can be (de) activated based on the mobility pattern of the second communication device and the location of the first communication device. This aspect may be implemented independently or in combination with the other embodiments herein described.

Further, the above embodiment can be enhanced by a method capable of storing on the first communication device information related to the location and/or mobility pattern of the second communication device and/or storing on the second communication device information related to the location and/or mobility pattern of the first communication device.

In general, the above embodiments can be enhanced by a method that provides the core network, e.g., AMF, the capability to configure (store, manage, . . . ) the communication parameters or the credentials required to establish said communication parameters in those communication devices that are authorized to interact with each other.

Similarly, under this embodiment, it is proposed a first communication device adapted to store configuration parameters for a communication link with a second communication device and configured to activate or deactivate said communication parameters and said computation link given the mobility pattern of the second communication device.

Similarly, the above embodiment provides a second communication device adapted to store configuration parameters for a communication link with a first communication device and configured to activate or deactivate said communication parameters and said computation link given the mobility pattern of the second communication device.

Similarly, this first (or second) communication device may also be capable of receiving from a fourth communication device (e.g., a function in the core network) the communication parameters or credentials used to establish said communication parameters with the second (or first) communication device.

For instance, in an embodiment, a set of IAB communication parameters between the first and second communication devices might be initially established according to current procedures the first time the second communication device is in RAN communication range of the first communication device.

For instance, in an embodiment, a set of IAB communication parameters between the first and second communication devices might be configured from the core network before the second communication device is in RAN communication range of the first communication device. In this case, only authorized devices might be allowed to receive the set of communication parameters in an initial configuration and provisioning phase.

For instance, in an embodiment, a set of IAB communication parameters between the first and second communication devices might be established between the second communication device and the first communication device before both devices are within RAN communication range, e.g., by executing existing methods (e.g., F1 interface) over a tunnel or retrieving/retrieving configuration from the first communication device.

For instance, in an embodiment, to ensure that the routing tables in BAP remain relatively stable, the capability of preventing a mobile base station from becoming a parent node in the IAB can be used. This can be done by modifying the integration procedure in 3GPP TS 38.401, Section 8.12, Phase 1. Here, when the IAB mobile termination (IAB-MT) includes the IAB-node indication in the RRCSetupComplete message, to indicate its IAB capability, and this connection is being established over a mobile gNB node, the mobile gNB node could release such a connection request. An alternative implementation or design consists in including information about the type of base station in the system information broadcasted by a gNB-DU, e.g., in system information SIB1. For instance, a bit might be included in the SIB to indicate whether a base station is a mobile relay or not. The MT of a IAB might contain a policy that skips base stations that identify themselves as mobile base stations. An addition to this may be that this policy might also consider positioning information of such (mobile) base stations. E.g., if mobile base station A is moving along another mobile base station B (e.g., two buses moving one behind the other), and mobile base station A becomes aware of this positioning information (e.g., if mobile base station B discloses it in a SIB, or mobile base station A is informed by the CN), then mobile base station A might also prefer such a mobile station B as a parent IAB. The above embodiments ensure that UEs can only connect to a mobile base station that is directly connected to a donor gNB. The above approaches can be generalized if in the RRCSetupComplete the IAB-node indicates its IAB capability and the receiving IAB node rejects or accepts the connection based on a given policy configured by the core network and its own configuration data. For instance, if a receiving IAB-node that is also a base station 1-hop/2-hops away of the donor gNB has a policy stating that mobile base stations support a maximum of, e.g., 2 hops, then the receiving IAB-node will accept/reject the connection. Similarly, the above approach can be generalized if the IAB-node (mobile base station) broadcasts its presence including whether other mobile base stations can connect to it, or even the maximum number of hops that can connect. For instance, if a maximum number of 3 hops is allowed, a first mobile base station 1-hop away of the donor gNB might indicate that 2 hops are available in its SIB. Thus, if a second mobile base station serving a third base station tries to connect, either the second mobile base station will try (since it is allowed by a policy) or the first mobile base station will allow (since it is allowed by the policy).

More generally, it is thus proposed a method for limiting the depth of a multihop communication link (e.g., an IAB-based connection over mobile base stations) based on information shared in either broadcast (e.g., SIB) or in unicast (e.g., a RRCSetupComplete) messages, a policy, e.g., configured by a managing entity (e.g., the donor gNB or core network) including, e.g., the maximum number of hops allowed, and a local configuration value (e.g., number of hops from the donor gNB). This aspect can thus be implemented independently or in combination with the other embodiments of the invention. Similarly, it is proposed a first communication device (e.g., a mobile base station) attempting to establish a communication link with a managing entity (e.g., donor gNB) over at least a second communication device (e.g., mobile base station) connected to the managing entity) adapted to determine whether it is allowed to establish the connection based on an information field in broadcast message (e.g., SIB1) or unicast message (e.g., RRC message) sent by the second communication device and a policy configured in the first communication device.

Similarly, it is proposed under this embodiment a second communication device (e.g., a mobile base station connected to a managing entity (e.g., donor gNB)) adapted to determine whether a first communication device (e.g., a mobile base station) is allowed to establish the connection based on an information field in a unicast message (e.g., RRC message) sent by the first communication device and a policy configured in the second communication device and a local configuration value.

For instance, in an embodiment, in Section 8.9.13 in 3GPP TS 38.401, the IP address allocation for IAB-nodes is described. In the case of mobile base stations, instead of requiring the re-allocation of communication parameters every time, the IAB-node can just request the reactivation of communication parameters (e.g., IP address(es)) via RRC to the IAB-donor CU). This reactivation might also include a reactivation of mappings between internet protocol (IP) header fields and L2 parameters (e.g. BAP routing ID, BH radio link control (RLC) channels) used for downlink (DL) traffic. When an IP address is reactivated, the corresponding F1 interface can be re-enabled as well. Once the reactivation request is sent, the IAB node in the mobile base station can start communicating.

For instance, in an embodiment, when an IAB-MT enters an inactive state (e.g. INACTIVATE), 3GPP TS 38.401 states in Section 8.9.12 that it is up to the implementation to keep or release the F1 connection of the collocated IAB-DU. This F1 connection connects to the CU. In case a mobile base station following a given, e.g., periodic, route in which a DU will connect again and again to the same CU, the F1 connections may not be released (e.g. as described in Section 8.9.10.1 of 3GPP TS 38.401), but may remain preconfigured in the IAB-DU so that they can be rapidly activated when the MT is connected again to the same DU parent under the same CU. Similarly, the CU may store the F1 configuration so that it can be rapidly reactivated. The control part (CP) of the gNB-CU could indicate to user part (UP) of the gNB-CU over the E1 interface (connecting the CP and the UP) whether an F1 interface is active or not and whether it can or should be reactivated.

The above proposed options to improve IAB in the context of vehicle-mounted relays might not only apply to the use case of the above embodiment, but may also be independently applicable to other use cases, e.g. as described in 3GPP TR 22.839.

FIG. 4 schematically shows a signaling and processing diagram for a data distribution in a mobile edge or multi-access edge computing (MEC) environment according to an embodiment. Involved devices are a UE 10, a macro base station (gNB) 20, a CN 50 with AMF 52, CN MEC host 54 and MEC orchestrator 56, a domain name server (DN) 60 and a mobile base station (gNB) 30.

The MEC network architecture concept enables cloud computing capabilities and an IT service environment at the edge of a cellular network (e.g. 5G network) or any other network. The basic idea behind MEC is that by running applications and performing related processing tasks closer to the cellular customer, network congestion is reduced and applications perform better. MEC technology is designed to be implemented at cellular base stations or other edge nodes and enables flexible and rapid deployment of new applications and services for customers. Combining elements of information technology and telecommunications networking, MEC also allows cellular operators to open their RAN to authorized third parties, such as application developers and content providers.

In step 401 of FIG. 4, the UE 10 requests application data from the DN 60.

In step 402, the application requests the MEC orchestrator 56 to allocate MEC application/data close to the user. This might be a one-time request, or it might be a configuration request for that specific application and the UE 10. The MEC orchestrator 56 may be assumed to be within the CN 50 since it requires the allocation of resources for the given application in the mobile base stations, However, in other architectures, it could also be outside of the CN.

In step 403, the application uploads data to the MEC host 54.

In step 404, requested uploaded data is cached at the MEC host 54 of the CN 50, e.g., in the 5G core (5GC). This action might happen based on the specific request from the UE 10. This action might also happen proactively (e.g., during night) depending on the application preferences.

In step 405, the MEC orchestrator 56 checks with a corresponding 5G network function (NF), e.g., AMF 52 or SMF, a suitable mobile base station for delivering the data to the UE 10. This base station will host the MEC application/data (or Edge Application Server).

In step 406, the CN 50 (e.g. AMF 52) chooses a mobile base station (gNB) 30 based on the MEC requirements as received from the MEC orchestrator 56 and based on at least one of gNB status, positioning information, and UE position.

In step 407, the CN 50 (e.g. AMF 52) informs MEC orchestrator 56 of its selection and the MEC orchestrator 56 shares configuration data for the MEC application.

In step 408, CN 50 (e.g. AMF 52) forwards a request to the selected mobile base station (gNB) 30, through the macro base station (gNB) 20, to commission the MEC application for given configuration parameters. In particular, a local DNS server can be configured at this stage so that future UE requests are redirected to the edge application that will be hosted at the mobile base station 30. Referring to the example of FIG. 2, this may be done at location L0 and time T0.

In step 409, the MEC application/data is hosted at the mobile base station (gNB) 30.

In step 410, resource allocation is performed between the macro base station (gNB) 20 and the mobile base station (gNB) 30 to transfer the MEC application/data.

In step 411, the MEC application/data is transferred from the CN 50 (e.g. MEC host 54) to an MEC host (not shown) at the mobile base station (gNB) 30. Referring to the example of FIG. 2, this may be done at location L1 and time T1. Note that this step may require the mobile base station 30 to join the macro cell, which may involve mobility and RAN optimizations described in other embodiments.

In step 412, the MEC host at the mobile base station 30 hosts the requested application/data.

In step 413, the UE 10 requests application data from the mobile base station 30. Note that this step may require the UE 10 to join the mobile base station 30, which may involve mobility and RAN optimizations described in other embodiments.

Finally, in step 414, the requested application data is transferred to the UE 10. Referring to the example of FIG. 2, this may be done at location L3 and time T3.

In this embodiment, the UE 10 can have an active communication link with a decreased communication delay by relaying data. More specifically, an MEC application is first commissioned at the mobile base station (gNB) 30 where the data is transferred (e.g. at location L1 and time T1 of FIG. 2)) by means of the MEC infrastructure upon request of the CN 50 (where the MEC orchestrator 56 is located) based on the application request. The UE 10 accessed the MEC application mimicking an end-to-end communication architecture (e.g. at location L3 and time T3 of FIG. 2).

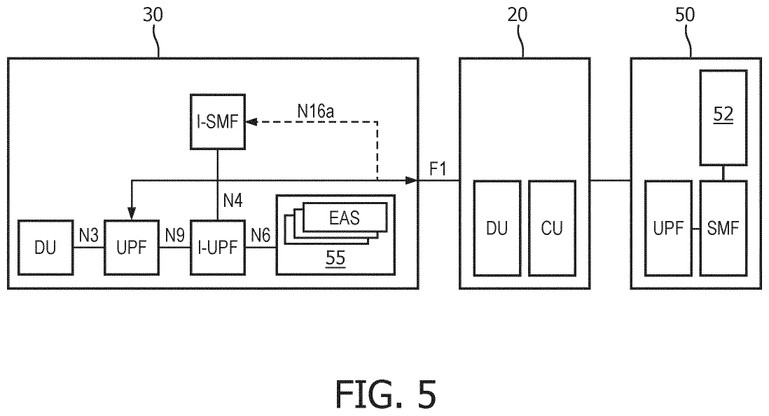

FIG. 5 schematically shows a block diagram of an exemplary instantiation of a mobile base station and overall system in which the data distribution procedure of FIG. 4 can be implemented.

In FIG. 5, an exemplary mobile network deployment with the mobile base station 30 includes an initial user plane function (I-UPF) that is routed by means of a UPF (using e.g. an uplink (UL) classifier (CL) or branching point (BP)). Such an I-UPF may be placed close to the access network (e.g. RAN) and may be deployed on demand in step 409 of FIG. 4 or it could be preconfigured. The communication flow can be controlled by means of the I-SMF through an N4 interface. The protocol used here may be the Packet Forwarding Control Protocol (PFCP, as described in 3GPP TS 29.244).

Furthermore, the I-SMF may control an operation of a local UPF functionality connected to the macro base station 20 via an F1 interface. The configuration of the I-SMF may be distributed from an SMF in the 5G CN 50. Furthermore, a local access DN 55 may be configured to host the edge application server (EAS) or MEC application. This is the data that the UE 10 is requesting or is going to request and is downloaded at the mobile base station 30 in step 411 of FIG. 4.

Following the flows in Figure 6.46.2-1 of 3GPP TS 23.548, a local packet data unit (PDU) session anchor (PSA) UPF (equivalent to the I-UPF of FIG. 5) can monitor the quality of service (Qos) (e.g. in the RAN). This information can be reported to a local network exposure function (NEF). This local NEF can also be deployed in step 409 in FIG. 4. The local NEF can then notify a local application function (AF) that could also be deployed in step 409 of FIG. 4. If a low QoS is reported, PSA relocation and/or EAS relocation may happen as described in section 6.3 of 3GPP TS 23.548. For instance, a first local AF might be a local AF in the 5G CN 50 that handles the delivery of data through the macro cell (i.e. macro base station 20). If this local AF notices that the QoS when downloading data as requested by the UE 10 drops, a new local AF or local NEF or local PSA can be commissioned in the mobile base station 30 to serve the needs of the UE 10. The underlying message flow may correspond to the one described, e.g., in Figure 6.3.3.3.1.1-1 of 3GPP TS 23.548. It is however noted that this situation may also trigger other actions such as a CHO as described above.

In 3GPP TS 23.548, multiple connectivity modes for edge computing in the 5G CN 50 are described including a distributed anchor point, session breakout, and multiple PDU sessions. FIG. 4 describes an approach that could fit in multiple connectivity models. In case of a distributed anchor, section 6.2.2.2 of TS 23.548 describes how the EAS discover procedure could work. For instance, the DNS request may be resolved by a DNS server (e.g. DN 60) that is close to the PSA UPF. In the case of FIG. 4, a local DNS server may be updated in step 408 and the local PSA UPF may be configured in step 411 together with the application data. In FIG. 5, the local PSA UPF is shown as the I-UPF and the application data may correspond to the EAS.

In TS 23.502, general 5GC procedures are described. Section 4.23 describes deployment topologies with specific SMF areas. This may be relevant since, in general, the AMF determines an SMF capable of serving the UE 10 and the SMF manages the corresponding UPF. In particular, section 4.23.9 describes how an BP or UL CL is established so that the downlink data comes from either UPF (PSA2) (local UPF) or UPF (PSA1) (central UPF). Taking into account this operation, step 406 of FIG. 4 could refer therefore to the choice of SMF and UPF located at a given mobile base station. In this step, a BP or UL CL can be established to steer the download of data, e.g., through a central UPF connecting to a remote DN or through a local UPF located at the mobile base station 30 where the application data or edge server or EAS has been cached on demand. The steering can be done by downloading a configuration to the SMF local to the mobile base station 30. This proposed capability applies not only to the main use case of the above embodiment, but also to other use cases, e.g. as described in 3GPP TR 22.839. For instance, it can apply to the upload of data through a mobile base station.

The above communication flow can fit to, e.g., the EAS discovery procedure with EASDF described in connection with Figure 6.2.3.2.2-1 in 3GPP TS 23.548 where there is PSA UPF in a local site, i.e., close to the UE location, and a central PSA UPF.

The logic in FIG. 4 is related to the logic in Figure 6.2.3.3-1 (EAS re-discovery procedure at Edge relocation) in 3GPP TS 23.548. However, a fundamental difference is the mobility of the mobile base station 30 that brings new possibilities, namely the relocation of the EAS to it when the mobile base station 30 is close to the UE 10. This event and the location of the mobile base station 30 may trigger the L-PSA insertion, change or removal of PDU session. This may also trigger a notification towards the AF. For performance purposes, the capabilities and rights for EAS relocation might be under the supervision of the 5G CN 50, e.g., under the supervision of the SMF. This proposed capability applies not only to the main use case of the above embodiment, but also to other use cases, e.g. as described in 3GPP TR 22.839.

FIG. 6 schematically shows a signaling and processing diagram for an example according to an embodiment without using MEC, where a downlink data is cached at a mobile base station until it can be delivered. Involved devices are a UE 10, a macro base station (gNB) 20, a CN 50 with AMF 52, a domain name server (DN) 60 and a mobile base station (gNB) 30.

The idea of this embodiment is that the downlink communication is routed through the mobile base station (gNB) 30 and the data is cached at the mobile base station 30 until it can be delivered.

In step 601, the UE 10 requests application data from the DN 60.

In step 602a, the requested application starts delivering data.

In step 602b, the macro base station 20 determines that the amount of data is big and the communication link is not sufficient and therefore the data is cached at the macro base station (gNB) 20.

In step 603, the AMF 52 checks whether there is a mobile base station (gNB) capable of delivering the data.

In step 604, if available, the AMF 52 configures a detected mobile base station (gNB) 30 in advance, e.g., when it is at location L0 of FIG. 2.

In step 605, the macro base station 20 allocates resources for data transfer to the mobile base station 30, e.g., in an IAB setting.

In step 606, data is transferred to the mobile base station 30, e.g., when it is at location L1 of FIG. 2.

In step 607, data is cached at the mobile base station 30 since the UE 10 is not connected yet.

In step 608, the UE 10 is connected and the cached data is transferred to the UE 10, e.g., when the mobile base station 30 is at location L3 of FIG. 2.

In an example, the mobile base station (gNB) 30 may include an Intermediate UPF (I-UPF) controlled by means of the N4 interface. Here, packet forwarding control protocol (PFCP) sessions, established with this UPF, may define how packets are identified (e.g. by using a packet detection rule (PDR)), forwarded (e.g. by using forwarding action rules (FARs)), processed (e.g. by using buffering action rules (BARs)), marked (e.g. by using QoS enforcement rules (QERs)) and/or reported (e.g. by using usage reporting rules (URRs)). As described in 3GPP TS 29.244, a BAR can provide instructions to control the buffering behavior of this UPF at the mobile base station. The BAR may control the buffering behavior for all FARs of the PFCP session. Specific actions are described in section 5.2.4.2 of 3GPP TS 29.244 while section 8.2.29 includes a DL buffering duration. This proposed capability applies not only to the main use case of the above embodiment, but also to other use cases, e.g. as described in 3GPP TR 22.839. For instance, it can apply to the upload of data through a mobile base station that might be cached for a certain amount of time.

In another example, multiple mobile base stations might be coordinated in this manner when delivering (DL) or receiving (UL) from a UE. Each of those mobile base stations might include an I-UPF coordinated by means of, e.g., the same SMF, e.g. as described in section 5.33.2.2 of 3GPP TS 23.501 where two N3 tunnels are transferred via disjointed transport layer paths to support redundant transmission.

In a still further example, the data transfers in steps 408 and 414 in FIG. 4 and steps 606 and 608 in FIG. 6 may be chosen to be performed at locations where the best connectivity between the macro base station 20 and the mobile base station 30 and between the UE 10 and the mobile base station is determined.

In a still further example, the data transfer in steps 408 and 414 in FIG. 4 and steps 606 and 608 in FIG. 6 may be chosen to be performed at a same location L2 where the best end-to-end connectivity between macro base station 20 and mobile base station 30 and UE 10 is determined. This location is, e.g., location L2 regarding FIG. 10 and FIG. 11. If this location is chosen, the mobile base station might just route the data and the data might be temporary stored or cached at the donor base station 20 or an edge server close to the UE and done as described in other embodiments of this invention.

The RAN connectivity between the mobile base station (gNB) 30 and the macro base station (gNB) 20 and/or the UE 10 can be optimized based on a knowledge of the traveling route of the mobile base station 30 and the location of the UE 10. We note that the RAN connectivity might refer to (i) a link connection (e.g., mobile base station (gNB) 30 and the macro base station (gNB) 20; or mobile base station (gNB) 30 and the UE 10) or (ii) the end-to-end connectivity from UE 10 to macro base station (gNB) 20 over mobile base station (gNB) 30 as shown in FIG. 11.

Using the location of the macro base station (gNB) 20 and (route of) the mobile base station (gNB) 30 over time for pre-configured and/or predicted communication parameters, wherein both the mobile base station 30 and the macro base station 20 may use knowledge of their position to optimize communication parameters such as beam forming or modulation and coding scheme and/or reduce signaling overhead.

Since the mobile base station 30 may be moving fast, reporting the connection parameters (e.g., CQI)) to decide on the fly on the communication parameters to use, e.g., modulation or beam forming, may not be fast enough or may involve high signaling overhead. Even if reporting of CQI can be done at a high rate, the report may arrive with some delay. If the mobile base station 30 is moving, the communication environment and location of the mobile base station 30 may have changed already by the time the CQI report has been received and/or processed. This means that the macro base station 20 may be assigning communication parameters at time t based on outdated CQI connection parameters from an earlier time t-delta. It is therefore required to predict the actual CQI connection parameters at time t given the outdated CQI connection parameters obtained at time t-delta.

For instance, a car moving at 50 km/h moves 1.38 cm in 1 ms and 13.8 m in 1 s. If the reception quality depends heavily on the location of the mobile base station 30, but this dependency does not change over time, then the historical data can be used to reduce the communication overhead and improve the selection of communication parameters.

In an example, the macro base station 20 and the mobile base station 30 may collect data about the most suitable communication settings, e.g., beam forming, or performance, e.g., CQI, based on the positioning information of the mobile base station 30. This positioning information can include the absolute location (e.g., coordinates x, y, z), its angle with respect to a reference axis (e.g., 1 degree), its speed, or its acceleration. With this information, the macro base station 20 can pre-configure and select communication parameters for different locations of the mobile base station 30. The mobile base station 30 can adjust some of its own communication parameters (e.g., its own beamforming) based on its own positioning information. The mobile base station 30 may report its positioning information to the macro base station at a given instant of time. This can be done by means of a single or multiple messages. The positioning information may be included, e.g., in an uplink reporting message, e.g., together with other data such as in the CQI message as well. It can also be done by means of a single message including the current location and a speed vector (magnitude and direction). With this information, the macro base station 20 can select the best communication parameters.

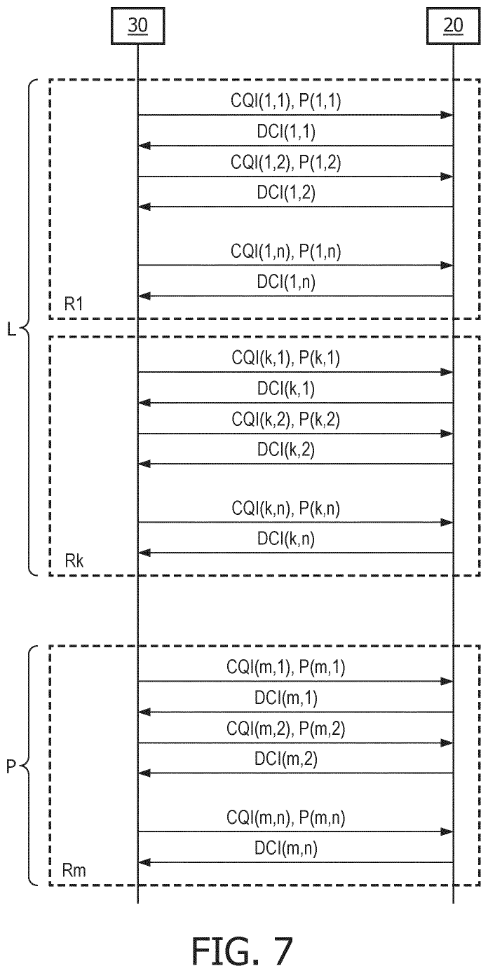

FIG. 7 schematically shows a flow diagram of a first responder network localization and mapping procedure according to various embodiments.

In order to get this operation running, the macro base station 20 may learn the route of the mobile base station (which always follows the same route) during a number of rounds, e.g., k rounds, where k is at least 1. In this learning phase L in round Rk, the mobile base station reports its connection parameters, e.g., the CQI(k,i) and positioning information P(k,i) for multiple locations i along the route of the mobile base station 30. The macro base station 20 will then allocate communication resources having no previous knowledge. The macro base station 20 stores this historical information. Since the mobile base station 30 reports the location, the macro base station 20 can also estimate the propagation delay of the message and its own processing delay. This means that after the learning phase L, the macro cell can have a table as follows:

| Position | CQI | Delta (delay) |
|---|---|---|
| P(0) | CQI(0) | D(0) |
| P(1) | CQI(1) | D(1) |
| P(n) | CQI(n) | D(n) |

Referring to FIG. 7, in a prediction phase P, the macro base station 20 can use the historical information and positioning information to make a better assignment of communication resources. During the prediction phase P, the macro base station 20 knows the route already and also the CQI along that route from the learning phase L. In this prediction phase in round Rm, the macro base station 20 can use the reported positioning information P (m,i) to estimate the actual position of the mobile base station 30 when the positioning information message arrives at the macro base station 20. This can be done since D(i) is known and P(m,i) can include speed information. The macro base station 20 can then look up the CQI for the entry that corresponds to the current location of the mobile base station 30. Note that additional data might influence this decision. This data might come from external sources, e.g., traffic status in the case of vehicle-mounted relays, weather, etc.

In the above example, a simple “table look up” is used to illustrate how positioning information can be used for an optimized allocation of communication resources. However, more advanced machine learning can be applied. For instance, the paper by Hao Yin et al, “Predicting Channel Quality Indicators for 5G Downlink Scheduling in a Deep Learning Approach” (August 2020) describes a related method for predicting the actual CQI value at time t based on historical data and CQI value reported by a UE at time t, that as discussed above will arrive with a certain delay, and thus, it will be outdated. This prediction is based on a long short-term memory (LSTM) algorithm. However, in that model the location and speed of the user (UE) is not used as input of the prediction algorithm used to estimate/choose communication parameters to be used between base station and UE. The reason why this input is not used is because the UE is the one assumed to be moving, and UEs can be moving at very different locations and directions. Therefore, the authors of the above paper could not assume that UEs are going to move in a repetitive fashion along the same route.

However, in the present embodiments, many mobile base stations, provided e.g. on buses or trains or satellites communicating with a fixed macro base station are going to have a fixed periodic/predictable route, and even similar speed every time as they move along such a predefined route. Thus, the current location of the mobile base station 30 and its speed vector are meaningful inputs when computing communication parameters.

Such parameters can be incorporated to, e.g., predicting channel quality indicators for downlink scheduling in a deep learning approach, by exchanging them, e.g., together with the CQI report. The positioning information might also be reported in a different way, e.g., broadcasted as part of signaling information. The input to the LSTM architecture of the above paper may not only include the last N CQI measurements, CQI (t−tau), CQI (t-tau+1), . . . , CQI (t-tau+N), but also the current positioning information of the mobile base station 30.

It is however noted that other machine learning algorithms, e.g., feedforward neural networks, convolutional neural networks (CNNs), etc. may also benefit from the usage of location information.

The above approach of the embodiment of FIG. 7 allows not only to improve the choice of communication resources, but can also allow reducing signaling overhead, and thus, energy consumption and bandwidth needs. For instance, during the prediction phase P, if the prediction capability is very good, the mobile base station 30 may only need to report the positioning information, and with a lower frequency. As another option, allocated resources may be deployed in advance to the mobile base station 30 by means of a semi-persistent scheduling approach in which the allocated resources are deployed by means of an RRC message.

The above proposed capabilities apply not only to the main use case of the above embodiments, but also to other use cases, e.g., as described in 3GPP TR 22.839, for instance, use cases focusing on the upload of data through a mobile base station.

Another option for optimizing the connectivity can be to select the best location for the data transfer. This selection can be done by collecting data regarding the communication quality (throughput, latency, . . . ) from one or multiple mobile base stations along their route by keeping track of the data and by using it to select the most suitable starting time for the uplink/downlink communication between mobile base station 30 and the macro base station. As another option, the selection can be based on a propagation model, such as a basic propagation model (e.g. Free-Space or Plane Earth Loss) for macro cell prediction. Here, a total signal loss may be predicted based on knowledge of the location, dimension and parameters for every tree or building and terrain feature in the area to be covered. Alternatively, an empirical model may be used, where parameters, such as received signal strength, frequency, antenna heights and/or terrain profiles, are derived from a particular environment through the use of extensive measurement and statistical analysis and then used in environments similar to the original measurements.

It is noted that the throughput T_t for a given instant of time depends on the achieved transmission rate TR for the chosen modulation and coding scheme TR (MCS_t) and the current block error rate B_t of the transport rate, as expressed in the following equation:

$$T\_t = TR ( MSC\_t ) * ( 1 - B\_t )$$

As explained above in connection with FIG. 7, the CQI for the mobile base station 30 can be predicted in advance. The predicted CQI can then be used to determine the modulation and coding scheme (MSC) to be used. Since the CQI for a location is known, it is also possible to estimate the block error rate B_t at that location.

In general, data regarding QCI, throughput, latency, signal strength, signal to noise ratio, etc. is monitored by the macro base station 20, e.g., by using feedback from the mobile base station 30. The macro base station 20 keeps track of historical data.

FIG. 8 shows characteristic curves of downlink throughput between macro base station 20 and mobile base station 30 vs. location of the mobile base station 30 based on historical data. As can be gathered from FIG. 8, data communication is feasible between positions pa1 and pa2.

This historical data can be used to select the best location for the mobile base station 30 to perform future data transfers. The selection can be based on information from a specific mobile base station or from multiple base stations.

Since the macro base station 20 and the mobile base station 30 know the amount of data to transfer and are aware of the expected transfer rate based on the historical data (and the positioning information reported by the mobile base station 30), the macro base station 20 can select the best starting time (based on the positioning data reported by the mobile base station 30) of the data transfer to finish the whole data transfer according to a given optimization goal.

The starting time to download data might be in control of different entities depending how the solution is built. An option might be to have it controlled by the CU of the macro base station 20. Another option is to control it by means of the local SMF. In this case, the SMF should receive positioning information from the different entities in the system and manage the throughput figures, as in the above curve of FIG. 8, and the corresponding optimization and scheduling.

In a first example, the macro base station 20 may aim at optimizing its overall communication resources by allocating the transfer of data between the macro base station 20 and mobile base station between locations pb1 and pb2 as shown in the middle curve of FIG. 8, i.e., around the location in which the throughput is expected to be the highest. In this way, the resources of the macro base station 20 and the mobile base station 30 are available for other communication links with other UEs or mobile base stations before and after the target data transfer. However, this comes at the price of introducing some additional latency since the transmission start only happens at position pb1, when it could have already started at pa1. We note that this decision takes into account two positions of the mobile base station 30. However, the transmission time (and thus, total amount of data to exchange) depends on the speed of the mobile base station 30. From this point of view, the curves in FIG. 8 assume that the mobile base station 30 is moving at constant speed. This also means that the choice of locations pb1 and pb2 also depends on the velocity/acceleration reported by the mobile base station 30.

However, if the macro base station 20 determines that the data transfer cannot be completed due to an excessive speed of the mobile base station 30, the macro base station 20 might command the mobile base station to adapt, e.g. reduce, its speed so that the transmission time between locations pb1 and pb2 is higher, and the whole data transfer can be completed. This feature can be used for certain types of vehicle-mounted relays, e.g., UAVs. The mobile base station 30 may also decide to adapt its speed on its own motion with the same goal. This proposed capability applies not only to the main use case in the above embodiments, but is also applicable to other use cases, e.g., as described in 3GPP TR 22.839.

The mobile base station 30 may also perform the optimization relying on external data sources such as traffic information (e.g., is there a traffic jam ahead or what is the timing of traffic lights) that may be requested from external data networks.

In a second example, an alternative optimization goal may be to minimize communication delay. This is shown in the lowest curve of FIG. 8, where the transmission of data starts at location pc1=pa1, i.e., as soon as the mobile base station 30 is in communication range. The data transfer finishes at location pc2, i.e., pc2<pb2, so that the end-to-end latency can be minimized since as soon as the macro base station 20 has the uploaded data from the mobile base station 30, the macro base station 20 can forward this data further towards the UE 10 (or towards the CN 50 in the case of an uplink communication). Similarly, as soon as the data is downloaded to the mobile base station 30, the mobile base station can start communicating with the UE 10.

It is further noted that in the middle and lower curves of FIG. 8 the integral of the throughput line between pb1 and pb2 equals the integral of the throughput line between pc1 and pc2, assuming that the mobile base station 30 is moving at constant speed between those locations.

Furthermore, optimized RAN connectivity between the UE 10 and the mobile base station 30 can be achieved by using the location of the UE 10 and the (route of) the mobile base station 30 over time for pre-configured and predicting communication parameters and selecting the best location for the data transfer. The optimization approaches can be similar, with the difference that now the information about the UE 10 might be less reliable.

A criterion to apply in the above approaches is about making the mobile base station 30 and the UE 10 aware of their positions before connecting and during the connection. The mobile base station 30 may need to be aware of the position of the UE 10 since then the mobile base station 30 can check historical data from previous UEs that were located at that the current UE position. The UE 10 may need to be aware of the position of the mobile base station 30 to e.g., adapt and predict which beams of the mobile base station 30 it can use during the communication.

For instance, when the mobile base station 30 has to select the best location for data transfer, the mobile base station 30 can keep historical data for the transfer of data with UEs at different locations along the route of the mobile base station 30. This can be “throughput curves” as in FIG. 8 for different locations. When the mobile base station 30 receives the request for transferring data to the UE 10 in its downlink, the mobile base station 30 may check the location of the UE 10 to select the “throughput curve” that suits the UE 10 best. This may be based on historical data, a propagation model, a combination thereof, etc. With the selected “throughput curve”, the mobile base station 30 can select when data upload/download should start depending on the optimization goals, similar to the middle and lower curves of FIG. 8.

For instance, when the mobile base station 30 has to estimate the CQI of the UE 10 to select its communication parameters, the mobile base station 30 may take as input the data (e.g. current CQI data) received from the UE 10, but the mobile base station 30 may also use as input its own location and velocity vectors to predict the actual CQI of the UE 10 at the new location of the mobile base station 30.

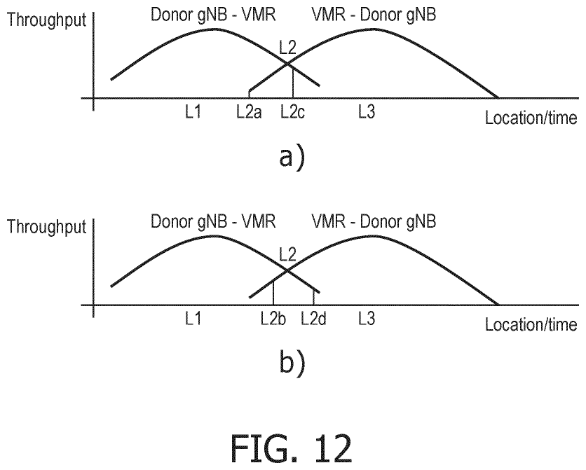

When optimizing the end-to-end connection from UE 10 to macro base station 20 over the mobile base station 30, the connection can also be optimized to minimize latency or minimize transmission time as shown in FIG. 12 a) and FIG. 12 b). In FIG. 12 a) the connection happens between locations L2a and L2c so that the latency is minimized. In FIG. 12 b) the connection happens between locations L2b and L2d so that the transmission time is minimized. Here, L2a<L2b<L2c<L2d and (L2c−L2a)> (L2d−L2b) and the mobile base station is assumed to move at constant speed.

The above embodiments enable efficient delivery of data through mobile base stations. Those embodiments are also applicable to at least some of the use cases described in 3GPP TR 22.839, e.g., to the upload of data through mobile base stations.

To this end, the network system (e.g. 5G system) may be configured to provide the following options:
The network system may support the use of a mobile base station (relay) that provides 5G access to UEs in the vehicle along the vehicle itinerary, and/or
the network system may provide means to ensure that UEs inside a vehicle, once provided with 5G access and connectivity via a mobile base station (e.g. mounted on the vehicle), remain connected via the mobile base station (e.g. mounted on the vehicle), and/or
the network system may be able to provide a means to optimize cell selection and minimize unnecessary cell reselection (between mobile base stations or between mobile base stations and a fixed base station) in the presence of mobile base stations (this requirement is intended to provide the capability for the 5G system (UEs and mobile base stations) to be able to optimize selection of a mobile base station, e.g., in a vehicle where the UE is on board (or that moved together so far or that is expected to move together)), and/or
the network system may be able to provide a means to minimize unnecessary handover (between mobile base stations, or between mobile base stations and a fixed base station) for a UE while served via an mobile base station, e.g., based on relative mobility or speed, and/or
the network system may support providing location service for the UEs accessing to the 5GS network via a mobile base station (e.g. mounted on a vehicle), and/or
the network system may support providing location information to a requesting UE or other location entity, for UEs accessing the 5GS network via a mobile base station (e.g. mounted on a vehicle), considering e.g. specific location granularity, and efficient UE power consumption, and/or
the network system may be able to provide a means to perform load balancing among mobile base station relays (this requirement is intended to provide the capability for the network system (UEs and mobile base stations) to be able to optimize the load of network resources whenever possible, and/or
the network system may be able to support efficient handover when a UE active communication changes from the macro network to a mobile base station (e.g. mounted on a vehicle) and vice versa, ensuring end-to-end service continuity during mobility of the UE (e.g. entering or leaving the vehicle) and/or the relay, and/or
the network system may be able to support efficient handover of a UE active communication when a mobile base station (e.g. serving a UE inside a vehicle) changes between macro network nodes, ensuring end-to-end service continuity during mobility of the relay, and/or
the network system may be able to support efficient handover of a UE active communication when a mobile base station (e.g. serving a UE outside a vehicle) changes between macro network nodes, ensuring end-to-end service continuity during mobility of the relay, and/or
the network system may be able to support efficient handover when a UE active communication changes between mobile base stations (e.g. mounted on a vehicle), ensuring end-to-end service continuity during mobility of the UE (e.g. moving inside the vehicle).

The above options in the above use cases and other use cases described in 3GPP TR 22.839 can be addressed with the following technical solutions:
Information, e.g., a bit being 0 or 1, is optionally included in a SIB, e.g., SIB1, to indicate whether a base station is a mobile base station (relay). By including this bit, a UE or IAB-MT can determine whether this is a cell it wants to join or not.
A mobile base station provides positioning data, e.g., in SIB1 or on demand on a new SIB. With this information, a UE can check whether its mobility pattern fits the mobility pattern of the mobile base station.
If a UE is connected to a mobile base station, it can request or obtain input on itinerary/timing. This can be delivered on demand as a new SIB. The SIB includes the current location of the base station as well as velocity (acceleration) vector. With this information, a UE knowing its own position can estimate how long the base station will be in range, configure communication parameters, and so on.
An option for the SIB is to contain its current location. This might be a suitable solution if this information is included in SIB1 since it is broadcasted in a periodic manner. SIB1 is broadcasted with a periodicity of 160 ms. Within this time spam, the same SIB1 is re-broadcasted multiple times, e.g., every 40 ms. If a vehicle is moving at 100 km/h, it will move 4.4 m in 160 ms. If the location of the mobile base station (gNB) is included in the SIB1, the SIB1 might include the position when a new SIB1 is broadcasted for first time and the velocity vector. With this information, if a UE receives a SIB1 that has been repeated 2 times, the UE can derive the position of the mobile base station. Other alternative might be to include the expected positions of the mobile base station for each SIB1 repetition.
Another option is that the location information is made available on demand, e.g., by including it in a new SIB that contains the route and timing of the mobile base station. An alternative option is to include the trajectory as a function of time. For instance, the current location, velocity vector, and expiration time. With this information, a UE (or macro cell (DU/CU)) can know its location until the expiration time.

More generally, in TS 23.273, Clause 4.3.5 it is stated that the target UE might support 4 modes of positioning including UE based mode and standalone. Thus, UEs that have subscribed to a positioning service might obtain this positioning information from the mobile base station.

More generally, it is proposed a method allowing a first communication device (e.g., a mobile base station) to provide localization services to one or more second communication devices (e.g., one or more UEs) by sending (e.g., in a broadcast message such as a SIB or an RRC protected message) localization data related to the mobility pattern of the first communication device. The first communication device might also use other interfaces, e.g., an IAB-base mobile base station has an MT-IAB that might be able to use the MT to send/broadcast discovery messages.

More generally, it is proposed a method allowing the second communication device to request access to the localization services to a network function in the 5GC, e.g., the LMF, and if allowed, the second communication device receiving a set of keying materials (e.g., a symmetric encryption key and/or a symmetric integrity key and/or a signature-verifying public key and/or a decryption private key) that can be used to decrypt or integrity verify the information distributed by the first communication device.

More generally, it is proposed a method allowing the first communication device to be authorized to provide localization services to one or more second communication devices and if authorized, to receive a set of keying materials (e.g., a symmetric encryption key and/or a symmetric integrity key and/or a signing private key and/or an encryption public key) that can be used by the first communication device to encrypt, or integrity protect the information distributed by the first communication device.

More generally, it is proposed a method allowing the location information to be encrypted with a symmetric key or with an encryption public key and the location information can be integrity protected by appending a message authentication code computed with an integrity symmetric key or appending a digital signature computed with a signing private key.

More generally, it is described a method allowing a second device authorized to receive the location information from a first device and optionally to decrypt and/or integrity verify it, and use this location information based on a policy configured by the core network. For instance: (1) If the second device observes that it is on the vehicle carrying the mobile base station, the second device will use the received location information and its position will be given by that location with the uncertainty of the vehicle size; (2) if the second device observes that it is not on the vehicle carrying the mobile station, the second device will only assume that it is somewhere in the communication range of the mobile base station.

Similarly, it is provided a first communication device implementing said methods, e.g., a first communication device capable of providing localization services to at least a second communication device by sending (e.g., in a broadcast message such as a SIB or an RRC protected message) localization data related to its mobility pattern. Similarly, it is provided a second communication device implementing said methods, e.g., a second communication device capable of receiving a message (e.g., a broadcast message such as a SIB or an RRC protected message) including localization data related to the mobility pattern of a first communication device and deriving from said localization data its own location.

The location measurement received from the mobile base station might be improved based on additional positioning techniques such as Angle of Arrival, Time of Flight, . . . or ranging measurements between the IAB-MT and the UE. In particular, if the mobile base station is located at a specific location in the vehicle, the mobile base station will distribute location information related to the specific location of the mobile base station (or any other part of the vehicle). A UE receiving the location information can further determine its position relative to the received location (of the base station itself) based on additional positioning techniques such as Angle of Arrival, Time of Flight, . . . or ranging measurements between the IAB-MT and the UE. For instance, in the case of Angle of Arrival, the UE can further refine its location based on the received location, the measured Angle of Arrival. The location measurement can also be further improved based on sensed information by either the UE or the mobile base station, e.g., information related to their orientations as obtained from a magnetic sensor and that might be exchanged between UE and mobile base station. The location measurement can be further refined by the UE (or mobile base station) by making using of the vehicle map that might be distributed by the mobile base station or make available to the UE in other way. For instance, in the case of a train, the mobile base station might also broadcast metadata (e.g., the size (length, width,), building materials, map, . . . ) related to the vehicle that can be used by the UE to further determine its location, including its absolute or relative location in the vehicle. For instance, if a UE measures a given Angle of Arrival, the UE can correct a potential error by knowing the measurements of the vehicle itself that can be received from the mobile base station. For instance, if a UE is reported a given Angle of Departure and knows the orientation of the mobile base station in the vehicle, the UE can better determine its location in the vehicle and its absolute position.

More generally, it is proposed a method as above, i.e., allowing a first communication device (e.g., a mobile base station) to provide localization services to one or more second communication devices (e.g., one or more UEs) by sending (e.g., in a broadcast message such as a SIB or an RRC protected message) localization data related to the mobility pattern of the first communication device, and providing metadata related to the vehicle or vehicle orientation and/or the location/orientation of the mobile base station in the vehicle. It is also provided first communication device implementing this method.

Furthermore, in general, it is proposed a second communication device (e.g., UE) capable of receiving from a first communication device (e.g., mobile base station) a first message (e.g., a broadcast message such as a SIB or an RRC protected message) including localization data related to the mobility pattern of the first communication device and/or other positioning signals (e.g., Angle of Arrival, Time of Flight, . . . ) and the second communication device using metadata (size, map, . . . ) about the vehicle (and/or mobile base station orientation/position in the vehicle) in combination with the localization data and/or the positioning signals to obtain a more accurate position estimation. It is further provided a second communication device that receives said metadata from the first communication device in a second message—that might be included in the first message. It is further provided a software application running on the second communication device and making use of the location information received in the first message from the second communication and the metadata information about the vehicle.

As described in the above embodiments, knowledge of the orientation of the mobile base station in the vehicle and knowledge of the orientation of the vehicle itself is required for an accurate estimation of the location of a UE when the UE performs the measurements by itself. This information is also relevant when an application in the core network or an application outside of the core network determine the location of a UE based on measurements performed by the UE. Thus, a mobile base station used to provide localization services to a UE is also required to provide its configuration (orientation/position of the mobile station related to the vehicle) as well as the orientation of the vehicle itself to said application. Measurements reported by the UE (e.g., Angle of Arrival) related to positioning signals broadcasted by the mobile base station at time t might be enhanced by the mobile base station with its orientation/configuration when those positioning signals were broadcasted at time t so that the target application can determine the location of the UE. Alternatively, the mobile base station might include required data (e.g., real time data such as orientation of the vehicle) in the positioning signals so that the UE can perform the measurement and report it accordingly ensuring that measurements and orientation values are synchronized. Therefore, it is further provided method allowing a second communication device to transmit to the first communication device a measurement of a positioning signal and the first communication device forwarding said measurement to a fourth communication device (e.g., an application in the core network) and the fourth communication device obtaining a location value of the second communication device considering the orientation of the first positioning device when the measurement was obtained. This method can be enhanced by letting the second communication device include the orientation of the first communication device as received in the measured positing signal in the measurement. This method can be enhanced by letting the first communication device to enhance the received measurement with its orientation before forwarding it to the fourth communication device.
When a UE is connecting to a mobile base station, the UE might use information about its own location to detect whether it is moving and whether its direction fits the route of the mobile base station. Only in this case, the UE will join that base station. For instance, this information can be derived from an accelerometer. This information can also allow deriving speed information. Alternatively, the UE can also request the mobile network to deliver its position, speed, and direction. The UE may also use other sensors, e.g., a GPS sensor.
In order to allow a UE to decide in an autonomous way whether it should connect to the mobile base station or to a normal base station, the UE can run a policy that states that if it is connected to a mobile relay and it is moving according to the route of the mobile relay, then the UE should remain connected to the relay even if it sees other base stations with stronger signal.
The above policy on a UE to decide to join a mobile base station only if it is a good candidate can also apply during handover. For instance, during CHO, the UE receives positioning information about the base station. A UE may decide to join it, only and only if it detects that it is also moving along the route of that mobile base station.
Similarly, a UE might run a policy stating that even if a UE detects some base stations with a high received signal when processing the received synchronization signal blocks (SSBs) containing the primary synchronization signal (PSS), the secondary synchronization signal (SSS), and master information block (MIB), the UE may not change cell as long as the UE detects that it is following the route of the mobile base station it is connected to.

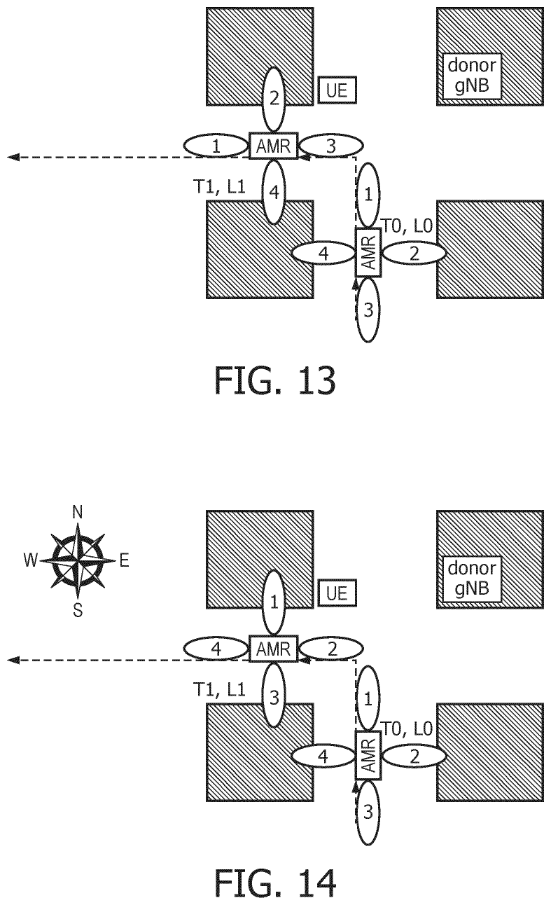

The mobile base station or vehicle mounted relay (VMR) may broadcast synchronization signals, in particular, it might broadcast synchronization signal blocks (SSBs) through different beams. The movement of the mobile base station can lead to the situation in which the reception of different beams changes in an abrupt manner. For instance, consider a VMR with four beams broadcasting the SSBs as in FIG. 13. Where beam 1 is directed towards the travelling direction, beam 2 on the right with respect to the traveling direction, beam 4 on the left with respect to the traveling direction, and beam 3 is directed in the opposite direction of travel. If this configuration is fixed and relative to the vehicle's traveling direction, then UEs around the VMR will suffer sudden changes in the SSB reception levels every time the VMR changes its direction of travel. To avoid this situation, the VMR should distribute its SSBs with a fixed distribution respect to an external (to the VMR) reference system. Such a distribution is shown in FIG. 14 where-independently of the traveling direction of the VMR-beam 1 points towards the north, beam 2 points towards the east, beam 3 points towards the south and beam 4 points towards the west. Doing this requires integrating information related to the external reference system (e.g., location of the north) into the beam management system of the VMR and adjust the direction of the beams of the VMR accordingly compensating for changes in direction of the VMR.
Similar to the last embodiment, the beam management system should take as a real time input the traveling information of the vehicle to adjust beamforming accordingly, and keep a stable connection with both the UE and donor gNB.
The above beam management approach is suitable for UEs that are not travelling with the VMR, but it is not suitable for UEs that are travelling with the VMR. For those UEs located in the vehicle it is more suitable to have one or multiple specific beams covering the interior of the vehicle and keeping a constant arragement independently of the vehicle travelling direction. To facilitate the acquisition of the VMR SSBs by the UEs, VMRs might use a specific SSB ordering where some of the beams (e.g., the first SSB) are broadcasted towards UEs located in the vehicle and the rest of the beams (e.g., the last SSBs) are broadcasted to allow the connection of UEs outside of the vehicle. The SSB, e.g., a bit in PBCH or MIB, might indicate if it is a VMR. The UEs might then decide which beam to choose depending on its own mobility information, i.e., knowledge of whether the UE is moving or not with the VMR.
In some cases, a mobile base station might not broadcast in the system information the fact that it is a mobile base station. If this is the case, a UE might trigger handover, in particular, it might send a measurement report to the source gNB(-DU) including the serving cell (e.g., the macro gNB) and a potential target neighboring cell signal strength. If the target neighboring cell signal strength is stronger, this would force the handover procedure. This could happen, e.g., if a mobile base station drives close to a UE. This can be avoided if the RAN (e.g., the CU of the gNB) or CN (e.g., AMF) check whether the target cell is a mobile base station and it is going to be in the current area of the UE (based on the position, speed, . . . of the mobile base station) long enough to provide service to the UE. If the target cell does not fulfil the requirements, the RAN or CN will inform the UE through the source gNB(-DU), e.g., by means of a RRC message, that the target cell is not suitable.
The above embodiments in this application, the connection between donor gNB and VMR is considered to rely on IAB and the connection between VMR and UE is considered to rely on NR Uu. An alternative approach consists in using NR Uu between gNB and VMR and PC5 between VMR and UE where the VMR is a relay UE and the UE is a remote UE. If this is done, optimizations for handover discussed in above embodiments apply between VMR and donor gNB. Optimizations related to the transfer of data are applicable in a similar way where the VMR (relay UE) will cache the data towards the remote UE for certain time. The discovery of remote UE/relay UE and direct communication request can also be improved in a similar way to a CHO. For instance, the donor gNB might inform the remote UE through a control message, e.g., an RRC message, of the approaching VMR (relay UE) based on its mobility pattern (location, speed, . . . ). In this control message, the donor gNB might include information contained in the discovery messages (model A/B). For instance, the donor gNB might trigger the initial provisioning and authorization step required in the discovery procedure (e.g., Solutions 3 and 4 in TR 33.847) so that UE and VMR can successfully discover each other. For instance, the donor gNB might also collect the direct communication request from the remote UE and share it with the relay UE and or CN to verify whether the relay UE is capable/allowed to handle the remote UE/relay UE connection before the remote UE actually connects to the relay UE. The CN could also prepare and deliver the reply to both remote UE and relay UE before they have discovered each other. Finally, the donor gNB, or the CN through the donor gNB, might distribute keying material, e.g., a symmetric key, to protect the PC5 link once it is available. For instance, in case that remote UE and relay UE perform a distributed discovery and PC5 establishment procedure, i.e., without involvement of CN based on some pre-distributed keying materials, e.g., public keys and certificates as described in 2021PF00120, this distributed protocol, or part of it might be through the donor gNB before remote UE and relay UE are in range.

In an embodiment, the mobile base station announces its presence by means of the sidelink synchronization signals exchanged over sidelink with the aim of reducing interferences (e.g., colliding PCI) by mobile base stations when they move around. UEs monitor sidelink synchronization signals (SSS) that might include an indication of the VMR/mobile base station capability. Once the SSS have been observed, the UE might monitor the distribution of discovery messages, e.g., announcement messages broadcasted/sent by the IAB-MT (UE part of the mobile base station) and that might include parameters (e.g., in the metadata field of the discovery message) that allow an authorized UE to access the mobile base station, e.g., RACH related parameters. In a final step, the UE might then access the mobile base station.
In the above use cases and in other embodiments, a UE may also refer to the IAB mobile termination (IAB-MT) unit.
The network system might be able to support optimized data delivery to the UEs onboard of a mobile base station by choosing a location for the data transfers that, e.g., maximizes the throughput or ensures a minimum throughput level from the donor access device to the UEs through the mobile base station. For instance, this might refer to a set of locations between L1 and L2 around the donor access device. Protocols such as mobility and RAN should be optimized between these locations.

In another embodiment, the CN can also choose to distribute the data through two mobile base stations, e.g., if none of the base stations will be close to the UE long enough to handle all data. For instance, a base station can handle the uplink data and another base station can handle the downlink data.

From this point of view, the CN should be in charge of balancing the load on the mobile base stations based on the amount of data they can handle and also the timing and quality of the communication link that the mobile base stations can establish.

This can be achieved by providing multiple gNB-UPs, e.g. two of them. Two mobile base stations would run the gNB-UP and the macro base station can be in charge of the gNB-CP. Alternatively, a mobile base station can run the gNB-UP and the macro base station the gNB-CP and UP. The goal for load balancing is that the gNB-CP can balance the load distributed to both mobile base stations running the gNB-UPs. The following extensions may be required to achieve this extended architecture:
Upon UE selection, base stations may indicate whether they support CP or UP or both (legacy) in the broadcasted system information. The UE may first join the gNB-CP. Then the UE may join at least one gNB-UP depending on its policy. A feasible split may be to have two gNB-UP in charge of uplink and downlink traffic.
In an UE attachment signaling procedure in an NR-NR architecture, the gNB-CP may add a gNB-UP. The gNB-CP could also add more than one gNB-UP to distribute the traffic load.
In a handover process, when performing load balancing, the gNB-CP may distribute the load between the source gNB-UP and the target gNB-UP, e.g., for the downlink, taking into account the user data to be downloaded and the positions of the source gNB-UP and the target gNB-UP.

FIG. 9 shows an example of throughput curves vs. location that a gNB-CP can expect from a source gNB-UP 1 (MBS1) and a target gNB-UP 2 (MBS2) when connecting at a UE taking into account the routes of both mobile base stations. This information can be estimated as described above e.g. in connection with FIG. 7.

As shown in the upper curve of FIG. 9, data communication at the source gNB-UP 1 (MBS1) is feasible between positions pa_s1 and pa_s2, while data communication at the target gNB-UP 2 (MBS2) is feasible between positions pa_t1 and pa_t2

In an example, load balancing can be performed by distributing the load (downlink data to be sent to the UE) between mobile gNB-UP 1 (MBS1) and mobile gNB-UP 2 (MBS2).

As shown in the lower curve of FIG. 9, data distribution is controlled so that at location pb0 the UE attaches to the gNB-CP and thereafter to gNB-UP 1 (MBS1). Then, at location pb1 data downlink transfer from gNB-UP 1 (MBS1) is started. During this first downlink transfer, the gNB-CP preconfigures in the UE the location of gNB-UP 1 (MBS1) that triggers a handover, and potentially, caches data in gNB-UP 2 (MBS2) for download to the UE when it has joined. Shortly before the location pb2 where the data download from gNB-UP 1 (MBS1) ends, the UE performs a random access procedure with gNB-UP 2 (MBS2). Then, at location pb2 data downlink transfer from gNB-UP 2 (MBS2) is started and continues until location pb3.

To summarize, an improved provision of download capability has been described for terminal devices (e.g. smart phones or IoT devices) in a network system by introducing a capability of caching requested data at mobile access devices (e.g. base stations (such as gNBs) or access points) and optimizing scheduling/transfer of data between terminal device and mobile access device and between mobile access device and macro access device.

While the invention has been illustrated and described in detail in the drawings and foregoing description, such illustration and description are to be considered illustrative or exemplary and not restrictive. The invention is not limited to the disclosed embodiments. It can be applied to various types of terminal devices, such as mobile phone, vital signs monitoring/telemetry devices, smartwatches, detectors or other type of portable device.

The terminal devices can be different types of devices, e.g. mobile phones, vehicles (for vehicle-to-vehicle (V2V) communication or more general vehicle-to-everything (V2X) communication), V2X devices, IoT hubs, IoT devices, including low-power medical sensors for health monitoring, medical (emergency) diagnosis and treatment devices, for hospital use or first-responder use, virtual reality (VR) headsets, etc.

The base station may be any network access device (such as a base station, Node B (eNB, eNodeB, gNB, gNodeB, ng-eNB, etc.), access point or the like) that provides a geographical service area.

Furthermore, at least some of the above embodiments may be based on a 5G New Radio (5G NR) radio access technology.

Moreover, the invention can be applied in medical applications or connected healthcare in which multiple wireless (e.g. 4G/5G) connected sensor or actuator nodes participate, in medical applications or connected healthcare in which a wireless (e.g. 4G/5G) connected equipment consumes or generates occasionally a continuous data stream of a certain average data rate, for example video, ultrasound, X-Ray, Computed Tomography (CT) imaging devices, real-time patient sensors, audio or voice or video streaming devices used by medical staff. In particular, this can be used in emergency healthcare situations, e.g., where an ambulance-mounted relay is used to improve the connectivity in the emergency area, e.g., an accident. In general IoT applications involving wireless, mobile or stationary, sensor or actuator nodes (e.g. smart city, logistics, farming, etc.), in emergency services and critical communication applications, in V2X systems, in systems for improved coverage for 5G cellular networks using high-frequency (e.g. mmWave) RF, and any other application areas of 5G communication where relaying is used.

Other variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality. A single processor or other unit may fulfil the functions of several items recited in the claims. The mere fact that certain measures are recited in mutually different dependent claims does not indicate that a combination of these measures cannot be used to advantage. The foregoing description details certain embodiments of the invention. It will be appreciated, however, that no matter how detailed the foregoing appears in the text, the invention may be practiced in many ways, and is therefore not limited to the embodiments disclosed. It should be noted that the use of particular terminology when describing certain features or aspects of the invention should not be taken to imply that the terminology is being re-defined herein to be restricted to include any specific characteristics of the features or aspects of the invention with which that terminology is associated. Additionally, the expression “at least one of A, B, and C” is to be understood as disjunctive, i.e. as “A and/or B and/or C”.

A single unit or device may fulfill the functions of several items recited in the claims. The mere fact that certain measures are recited in mutually different dependent claims does not indicate that a combination of these measures cannot be used to advantage.

The described operations like those indicated in FIGS. 3, 4 and 6 can be implemented as program code means of a computer program and/or as dedicated hardware of the related network device or function, respectively. The computer program may be stored and/or distributed on a suitable medium, such as an optical storage medium or a solid-state medium, supplied together with or as part of other hardware, but may also be distributed in other forms, such as via the Internet or other wired or wireless telecommunication systems.

1. An apparatus for controlling upload or download of transmission data in a wireless network, wherein the apparatus is configured to:
select a mobile access device based on estimated location information of the mobile access device and location information of a target device;
cache the transmission data, and
schedule a transfer of the transmission data to the mobile access device and a subsequent transfer of the transmission data by performing a transmission data download from the mobile access device to the target device or by performing a transmission data upload to a core network of the wireless network based on the estimated location information of the mobile access device and the location information of the target device.

2. (canceled)

3. The apparatus of claim 1, configured to upload or download the transmission data via a macro access device when the mobile access device is in a predetermined range of the macro access device.

4. The apparatus of claim 1, further configured to determine which of a plurality of mobile access devices will be in a predetermined range of the target device taking into account current traveling schedules of the mobile access devices and to identify which of the plurality of mobile access devices can deliver the transmission data to the target device taking into account the position information of the target device at a predetermined time, the positions of each of the plurality of mobile access devices at the predetermined time, and communication requirements of a user of the target device at the predetermined time.

5. The apparatus of claim 1, further configured to inform the selected mobile access device about at least one of a presence of the target device along a route of the mobile access device, data requirements of the user of the target device, and a position of the target device, so that the selected mobile access device can pre-optimize transmission parameters or pre-allocate transmission resources.

6. The apparatus of claim 1, further configured to select a suitable location of the mobile access device for the transfer of the transmission data and a suitable starting time for the uplink or downlink communication between the selected mobile access device and a macro access device serving the target device.

7. A wireless communication system comprising an apparatus of claim 1 and at least one mobile access device.

8. The system of claim 7, wherein the mobile access device is a vehicle-mounted access device configured to serve terminal devices located in the vehicle or in a predetermined range of the vehicle.

9. The system of claim 7, wherein the mobile access device is configured to pre-allocate and configure communication resources for the upload or download of the transmission data taking into account at least one of a required amount of data to transfer, the position information of the target device, an expected trajectory of the mobile access device and an expected time period during which the target device or a macro access device and the mobile access device will be in the predetermined range.

10. The system of claim 7, wherein a core network function or macro base station are configured to trigger a request for a conditional handover to the mobile access device once the mobile access device has been selected, or the target device is configured to send a radio resource control measurement report triggering the conditional handover request, or the target device is configured to send a request to trigger the conditional handover directly to a core network of the wireless network or the macro base station, or the target device is configured to join the mobile access device if it fulfils predetermined conditions such that a data transfer via the mobile access device can be initiated.

11. The system of claim 10, wherein the mobile access device and a macro access device serving the target device are instances of a split between a central unit and a distributed unit, wherein the mobile access device is a distributed unit and the macro access device is a central unit, wherein the central unit is configured to send to the target device a connection reconfiguration message including timing and conditions for moving from a source distributed unit to a target distributed unit, wherein the target device is configured to include information about a data delivery status in a randon-access procedure and/or a connection reconfiguration complete message, and wherein the transmission data is cached at the target distributed unit.

12. The system of claim 7, wherein the mobile access device further comprises an integrated access and backhaul, IAB, donor unit configured to create communication parameters in dependence on an estimated mobility information of the mobile access device, to activate the communication parameters when the mobile access device is in a predetermined range of the IAB donor unit, and to put the communication parameters on hold when the mobile access device is out of range of the IAB donor unit.

13. The system of claim 7, wherein the data is distributed in a mobile edge or multi-access edge computing, MEC, environment, wherein an MEC orchestrator of a core network of the wireless network is configured to select the mobile access device for delivering the transmission data to the target device, wherein an MEC application is first commissioned at the selected mobile access device and the transmission data is transferred upon request of the MEC orchestrator based on an application request from the target device.

14. (canceled)

15. (canceled)

16. A method of controlling upload or download of transmission data in a wireless network, wherein the method comprises:
selecting a mobile access device based on estimated location information of the mobile access device and location information of a target device;
initiating caching of the transmission data; and
scheduling a transfer of the transmission data to the mobile access device and a subsequent transfer of the cached transmission data by performing a transmission data download from the mobile access device to the target device or by performing a transmission data upload to a core network of the wireless network based on the estimated location information of the mobile access device and the location information of the target device.

17. The apparatus of claim 1 configured to cache the transmission data at the selected mobile access device or at the macro base station.

18. The system of claim 12, wherein the communication parameters are one or more of beam forming, modulation and coding scheme, L2 identifiers, IP addresses, routing tables, BAP entries, and F1 interfaces.
